(19) United States
(12) Patent Application Publication
(10) Pub. No.: US 2015/0211739 A1
(43) Pub. Date: Jul. 30, 2015

(54) INTEGRATED VALVE TRAIN WITH TOP-LOADING SELF-CONTAINED VALVE CARTRIDGES AND INTEGRATED VALVE PROVING SYSTEM

(71) Applicant: PROFIRE ENERGY, INC, Lindon, UT (US)

(72) Inventors: MARK R. LOVELESS, MAPLETON, UT (US); MELVIN HAL PARKS, PLEASANT GROVE, UT (US); JUSTIN W. HATCH, Spanish Fork, UT (US)

(21) Appl. No.: 14/594,076

(22) Filed: Jan. 9, 2015

Related U.S. Application Data
(60) Provisional application No. 61/925,397, filed on Jan. 9, 2014.

(51) Int. Cl. F23N 5/24; F16K 51/00

(52) U.S. Cl. CPC F23N 5/247; F16K 51/00; F23N 2035/16; F23N 2035/18; F23N 2035/24; F23N 2039/04

(57) ABSTRACT

A valve train system, apparatus, and methods including valve train modules integrating valve train functions wherein the valve train modules are configured for integration and include self-contained top-loading valve cartridges, an integrated valve train electrical system and an integrated valve proving system.

### PRIORITY

The present application claims the benefit under 35 U.S.C. §119(e) of U.S. Provisional Patent Application Ser. No. 61/925,397 filed on Jan. 9, 2014, which is incorporated herein by reference in its entirety.

### FIELD OF THE INVENTION

The present invention generally relates to an integrated valve train system for the control and straining of fuel used in combustion applications at oil and gas well sites. More specifically, the present invention relates to an integrated valve train system having top-loading self-contained valve cartridges and an integrated valve proving system.

### BACKGROUND

Natural gas derived from oil and gas wells is commonly diverted for use as a fuel supply for combustion applications operated at oil and gas well sites. Such combustion applications allow for the effective storage and processing of oil or gas derived from the well and may be used in association with combustion management systems, heater tanks, separators, treaters, amine re-boilers, and line heaters.

Fuel supply being directed to the burner unit and pilot in a combustion application is run through a valve train before the fuel reaches the combustion application. The valve train is used for, among other things, directing the fuel to the combustion application, straining or removing contaminants from the fuel, regulating gas pressure, and controlling fuel flow.

Valve trains at oil and gas well sites have historically been assembled at the well site by a serviceperson by piecing together components, and constructing the valve train for a particular combustion application utility on-site. The different components in the valve train have historically been connected using pipe nipples.

There are a number of disadvantages to valve train assembly, installation, and repair practices historically used at oil and gas well sites. One disadvantage is the large number of different parts that a serviceman must have onsite to assemble a valve train or have available when repairs are needed. Valve train configurations can vary widely depending on the applicable code-compliance, cost-sensitivity, and needs of the user. Using pipe nipple can be labor intensive and consequently time consuming and costly.

Additional assembly time, parts, and expense are also usually required for configuring pilot systems to work with the valve train and combustion applications. Systems for testing valve train leaks also require additional assembly, time, and parts to configure, which are commonly connected using pipe nipples diverted from the main line of the valve train. Valve proving systems currently available are typically add-on systems that must be externally piped to the valve train and often require special programming.

Another disadvantage to valve trains historically used at oil and gas well sites is the numerous connection points for electrical components, such as the control valve motor, pilot ignition, and electronic sensors, requiring various electrical wires to be fastened to the valve train and requiring properly securing and organizing the needed electrical wiring.

The cost in labor resources, parts, and time can be compounded when a valve malfunctions or is defective and needs replaced. Historically, a service person has been required to disassemble a section of the valve train to access a valve or regulator and disassemble the valve or regulator to determine which subpart of the valve or regulator needs to be fixed or replaced. In the disassembly process, there is an increased risk of losing components critical to functioning of the valve train. Moreover, valve and regulator repairs can cause significant down time for combustion application operations for oil and gas processing.

Another historical disadvantage in valve trains is the multiple potential leak paths not only in the valve trains, but in the individual pressure regulators, such as the main regulator and pilot regulator. Repairing the regulator or replacing regulator parts usually requires both top and bottom access to the regulator.

Some attempts have been made to address these issues. However, such attempts have not adequately addressed the disadvantages because they still require significant onsite assembly of valve trains or are not sufficiently adaptable for easy assembly of differing valve train configurations.

Thus, it is desirable to have an improved valve train system for integration of valve train components that reduces labor and costs for installing, replacing, and repairing regulators and valves.

### SUMMARY

It is an object of the present invention to provide an improved valve train system for combustion applications operated at oil and gas well sites. It is another object of the present invention to provide a valve train system having interchangeable valve modules with various valve train functionality. It is another object of the present invention to provide a valve train system having integrated components and functionality. It is also an object of the present invention to provide improved valve train components which permit increased integration of the valve train, reduce leak paths, and simplify assembly and repair of the valve train.

In accordance with one aspect of the present invention, a valve train system is provided wherein the valve train may be comprised of a sequence of valve train modules configured for various valve train functions. In accordance with an aspect of the present invention, the valve train modules may be configured to operably house valves and regulator and may be connected end-to-end in a stack formation. In accordance with another aspect of the present invention, the valve train modules may include manifold blocks having internally integrated fuel and pressure channels. Valve manifold blocks may also be referred to herein as valve train manifold blocks, valve train housings, valve housings, regulator housings, manifold blocks, valve manifold blocks, or regulator manifold blocks, as appropriate. Valve manifold as used herein may mean a cavity for housing or inserting valves.

In accordance with another aspect of the present invention, the valve train features and functions may be integrated between valve train modules. Valve train features and functions may also be integrated within individual valve train modules.

In according with another aspect of the present invention, the valve train housings may be cast or machined independently and configured so as to permit end-to-end connecting and integration of the housings with each other. The valve train housings may be configured so as to permit connection and integration of multiple and dissimilar functions within the valve train, such as pressure regulator and safety shut-off valve functions. The valve train housings may use a vertically elongated channel at a first or second end of the housing to transfer or receive fuel to or from a fuel port to permit the fuel to travel through the integrated valve train to permit connection of valve train modules having offset main fuel channels paths.

In accordance with another aspect of the present invention, a valve train module may include a fuel port for diverting pressure regulated fuel for operating solenoids within the integrated valve train. Fuel ports for operating solenoids may be connectable with fuel ports in other valve train housings of the present invention in order to transfer fuel for operation of solenoids in other sections of the integrated valve train.

In accordance with an aspect of the present invention, the valve manifold blocks may be machined or cast as a singular body. In accordance with another aspect of the present invention, the valve train manifold block may include a fuel port for transferring pressure regulated fuel through the valve train to a pilot. Fuel ports for operating the pilot may be connectable to pilot-associated fuel ports of other valve train housings in accordance with the present invention. In accordance with another aspect of the present invention, the valve train may be configurable for both external pilot and slip-stream functionality.

In accordance with another aspect of the present invention, the valve train modules may be configured with an integrated valve proving system. The integrated valve proving system may comprise fuel ports integrable between valve train manifold blocks and which may be associated with sensors for sensing fuel pressure and testing for fuel leaks within the valve train. A sensor such as an electronic pressure transducer may be disposed on the valve train housing and associated with the fuel ports of the integrated valve proving system to permit ongoing or continual data collection and testing for gas leaks. A secondary port may be provided whereby regulatory or auditing personnel may temporarily connect their gauges and/or other instruments to test for leaks. Said secondary port may have a plug or cap that may be removed in order to permit connecting of testing gauges or instruments and may be replaced when regulatory or auditing personnel complete their tests.

In accordance with another aspect of the present invention, the valve train housings may have integrable electrical ports for the electrical wiring to permit configuration of an integral electrical system within the valve train. The valve trains integrated electrical system may permit single point connection for all of the electrical components and/or for all of the operations of the integrated valve train system.

In accordance with yet another aspect of the present invention, the manifold blocks of the valve train modules may be configured to permit top loading of self-contained valves and regulators into valve manifolds configured within the manifold blocks. In according with another aspect of the present invention, the valve train housings train may be cast or machined as a complete singular and integral valve train body.

In accordance with another aspect of the present invention, valves and pressure regulators may be configured as self-contained cartridges which can be top loaded into the valve train housings. The self-contained configuration reduces leak points and reduces time and labor for repair and replacement of valves and regulators. In another aspect of the present invention, full functionality for each of the valves and regulators is contained within each of the respective self-contained valve and regulator cartridges. Each self-contained valve and regulator cartridge may be secured in its respective integrated valve manifold block using a snap ring.

In accordance with another aspect of the present invention, the pressure regulator of the present invention may be configured as singularly integrated body wherein the central regulator body and the lower bowl comprise a single solid unit, thus eliminating a leak path. The pressure regulator of the present invention may be configured to permit removing, repairing, and replacing the regulator without accessing or adjusting the middle and lower portions of the regulator.

Any of the self-contained valve or regulator cartridges may be installed, repaired, or replaced by simply removing an existing cartridge from the top of the respective integrated housing or stack unit and replacing the cartridge by inserting another functioning self-contained valve or regulator cartridge in the top of the housing or stack unit, said cartridge being secured with a snap ring.

The previously described aspects of the invention have many advantages, including, without limiting, reducing installation and repair time, reducing down time for combustion application operations, permitting full integration of a valve train, reducing the number of connection points for valve train electrical systems, reducing potential leak paths in valve trains, reducing the need for external add-ons, reducing the risk of losing critical components during maintenance, and safer operation of combustion applications for oil and gas processing such as heaters, among others.

These and other novel aspects of the present invention are realized in an integrated valve train system, apparatus, components, and methods as shown and described in the following figures and related description. Additional novel features and advantages of the invention will be set forth in the detailed description which follows, taken in conjunction with the accompanying drawings, which together illustrate by way of example, the features of the invention.

### BRIEF DESCRIPTION OF THE DRAWINGS

These and other features, aspects, and advantages of the present invention will become better understood with regard to the following description, appended claims, and accompanying drawings where:

FIG. 1 shows a front perspective view of an integrated valve train in accordance with one or more aspects of the present invention;

FIG. 2 shows a rear perspective view of an integrated valve train in accordance with one or more aspects of the present invention;

FIG. 3A shows a partially exploded view of an integrated valve train in accordance with one or more aspects of the present invention;

FIG. 3B shows a partially exploded view of an integrated valve train in accordance with one or more aspects of the present invention;

FIG. 4 shows a front cutaway view of an integrated valve train in accordance with one or more aspects of the present invention;

FIG. 5 shows a schematic of integrated fuel, pressure, and vent passages of an integrated valve train configured with a pilot and configured with separate vents for integrated valve train module sections in accordance with one or more aspects of the present invention;

FIG. 6 shows a schematic of integrated fuel, pressure, and vent passages of an integrated valve train configured with a pilot and configured with a common vent for integrated valve train module sections in accordance with one or more aspects of the present invention;

FIG. 7 shows a schematic of integrated fuel, pressure, and vent passages of an integrated valve train in a slip-stream configuration and configured with separate vents for integrated valve train module sections in accordance with one or more aspects of the present invention;

FIG. 8 shows a schematic of integrated fuel, pressure, and vent passages of an integrated valve train in a slip-stream configuration and configured a common vent for integrated valve train module sections in accordance with one or more aspects of the present invention;

FIG. 9 shows a partially exploded view of a Y strainer module of an integrated valve train in accordance with one or more aspects of the present invention;

FIG. 10A shows an upstream end cutaway view of a Y strainer module of an integrated valve train in accordance with one or more aspects of the present invention;

FIG. 10B shows a front cutaway view of a Y strainer module of an integrated valve train in accordance with one or more aspects of the present invention;

FIG. 11 shows a transparent view of a manifold block for a Y strainer module of an integrated valve train in accordance with one or more aspects of the present invention;

FIG. 12 shows a partially exploded view of a regulator module of an integrated valve train in accordance with one or more aspects of the present invention;

FIG. 13A shows an upstream end cutaway view of a regulator module of an integrated valve train in accordance with one or more aspects of the present invention;

FIG. 13B shows a front cutaway view of a regulator module of an integrated valve train in accordance with one or more aspects of the present invention;

FIG. 14 shows a transparent view of a manifold block for a regulator module of an integrated valve train in accordance with one or more aspects of the present invention;

FIG. 15 shows a perspective view of a self-contained regulator valve cartridge for use in a manifold block for a regulator module of an integrated valve train in accordance with one or more aspects of the present invention;

FIG. 16 shows an exploded view of a self-contained regulator valve cartridge in accordance with one or more aspects of the present invention;

FIG. 17 shows a cutaway view of a self-contained regulator valve cartridge in accordance with one or more aspects of the present invention;

FIG. 18 shows a partially exploded view of a pilot regulator module of an integrated valve train in accordance with one or more aspects of the present invention;

FIG. 19A shows an upstream end cutaway view of a pilot regulator module of an integrated valve train in accordance with one or more aspects of the present invention;

FIG. 19B shows a front cutaway view of a pilot regulator module of an integrated valve train in accordance with one or more aspects of the present invention;

FIG. 20 shows a transparent view of a manifold block for a pilot regulator module of an integrated valve train in accordance with one or more aspects of the present invention;

FIG. 21 shows a perspective view of a self-contained pilot regulator valve cartridge for use in a manifold block for a pilot regulator module of an integrated valve train in accordance with one or more aspects of the present invention;

FIG. 22 shows an exploded view of a self-contained pilot regulator valve cartridge in accordance with one or more aspects of the present invention;

FIG. 23A shows a cutaway view of a self-contained pilot regulator valve cartridge in a closed position in accordance with one or more aspects of the present invention;

FIG. 23B shows a cutaway view of a self-contained pilot regulator valve cartridge in an open position in accordance with one or more aspects of the present invention;

FIG. 24 shows a partially exploded view of a safety shut-off valve module of an integrated valve train in accordance with one or more aspects of the present invention;

FIG. 25A shows an upstream end cutaway view of a safety shut-off valve module of an integrated valve train in accordance with one or more aspects of the present invention;

FIG. 25B shows a front cutaway view of a safety shut-off valve module of an integrated valve train in accordance with one or more aspects of the present invention;

FIG. 26 shows a transparent view of a manifold block for a safety shut-off valve module of an integrated valve train in accordance with one or more aspects of the present invention;

FIG. 27 shows a perspective view of a self-contained safety shut-off valve cartridge for use in a manifold block for a safety shut-off valve module of an integrated valve train in accordance with one or more aspects of the present invention;

FIG. 28 shows an exploded view of a self-contained safety shut-off valve cartridge in accordance with one or more aspects of the present invention;

FIG. 29 shows a cutaway view of a self-contained safety shut-off valve cartridge in accordance with one or more aspects of the present invention;

FIG. 30 shows a partially exploded view of a control valve module of an integrated valve train in accordance with one or more aspects of the present invention;

FIG. 31A shows an upstream end cutaway view of control valve module of an integrated valve train in accordance with one or more aspects of the present invention;

FIG. 31B shows a front cutaway view of a control valve module of an integrated valve train in accordance with one or more aspects of the present invention;

FIG. 32 shows a transparent view of a manifold block for a control valve module of an integrated valve train in accordance with one or more aspects of the present invention;

FIG. 33 shows a perspective view of a self-contained control valve cartridge for use in a manifold block for a control valve module of an integrated valve train in accordance with one or more aspects of the present invention;

FIG. 34 shows an exploded view of a self-contained control valve cartridge in accordance with one or more aspects of the present invention; and

FIG. 35 shows a cutaway view of a self-contained control valve cartridge in accordance with one or more aspects of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

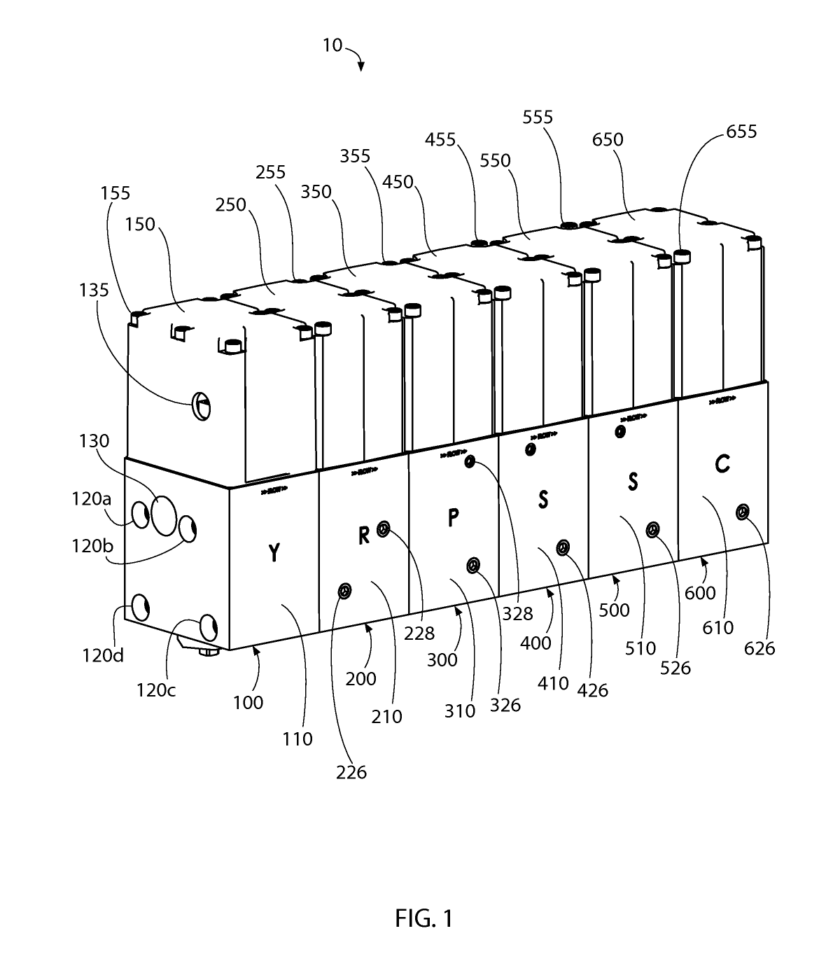

Referring now to FIGS. 1 through 4, an integrated valve train system for transfer and delivery of fuel to a combustion application for oil and gas processing is shown. As can be seen from the Figures, the integrated valve train 10 may be comprised of a plurality of valve train modules 100, 200, 300, 400, 500, 600 connected end-to-end sequentially. Each valve train module may perform a valve train function, including a Y strainer module 100 for straining fuel, a regulator module 200 for regulating fuel pressure, a pilot regulator module 300 for pilot and slip-stream functionality, safety shut-off valve modules 400, 500 for fail-safe and quick stopping of fuel flow in addition to general use to ensure shut-off of fuel flow, and a control valve module 600 to control conditions such as fuel flow, pressure, and temperature.

An advantage of the module configuration of the valve train of the present invention is that it allows quick interchangeability of valve functions and reduces potential leak points between valves. It also significantly reduces the labor and resources required for the upkeep and repair of the valve train 10.

Another advantage of the module assembly of the valve train system of the present invention is the ease and flexibility of changing the valve train configuration. In a preferred embodiment, the valve train 10 may include a first upstream valve train module comprised of a Y strainer module 100, followed in sequence by a regulator module 200, a pilot regulator module 300, a first safety shut-off valve module 400, a second safety shut-off valve module 500 to form a SSV (Safety Shut-off Valve) series, and an ultimate downstream module comprised of a control valve module 600. However, it should be understood that the module configuration of the valve train system of the present invention permits one to easily change the valve train configuration and function by adding or removing various valve train modules as well as changing the sequence or order of placement of valve train modules 100, 200, 300, 400, 500, 600 in the valve train system. Thus other valve train configurations may be provided without departing from the scope of the present invention. For example, in another embodiment, the control valve module 600 may be replaced with a pressure regulator module 200.

The valve train modules 100, 200, 300, 400, 500, 600 may be comprised of housings or manifold blocks 110, 210, 310, 410, 510, 610 that can be stacked end-to-end and operably house valve train components such as a fuel strainer and various valves and regulators used in the valve train system. One of the unique aspects of the present invention is the self-contained top loading configuration of the valve cartridges 260, 360, 460, 660 operated respectively in the regulator module 200, pilot regulator module 300, safety shut-off valve modules 400,500, and the control valve module 600.

The valve train manifold blocks 110, 210, 310, 410, 510, 610 may be composed of aluminum, stainless steel, plastic, composite, or any other machinable or castable material. In accordance with an aspect of the present invention, the valve manifold blocks may be machined or cast as a singular body. The valve train modules 100, 200, 300, 400, 500, 600 may be secured in a stacked configuration by securing the respective manifold blocks 110, 210, 310, 410, 510, 610 end-to-end using tie rods 125a, 125b, 125c, 125d or bolts which may be inserted through tie rod holes 120a, 120b, 120c, 120d extending through the respective manifold blocks. In a preferred embodiment, the tie rods 125a, 125b, 125c, 125d though holes through all but the ultimate downstream valve train module manifold block and may extend into and thread into the manifold block of the ultimate downstream valve train module in the sequences of valve train modules 100, 200, 300, 400, 500, 600. The tie rods 125a, 125b, 125c, 125d may be tightened to secure the manifold blocks 110, 210, 310, 410, 510, 610 together in a sequence and maintain the valve train modules 100, 200, 300, 400, 500, 600 in a stack formation. The connection surface between respective fuel ports of adjacent manifold blocks may be configured with one or more O-rings or other sealing device(s) to prevent fuel leaks between manifold blocks.

Each of valve train modules 100, 200, 300, 400, 500, 600 in the stacked sequence may also include an explosion proof housing cover 150, 250, 350, 450, 550, 650 secured on an upper side of the respective manifold blocks 110, 210, 310, 410, 510, 610 with elongated bolts 155. The explosion proof housing covers 150, 250, 350, 450, 550, 650 may function to contain unwanted combustion from ignition of fuel leaks from the valve train system. The explosion proof housing covers 150, 250, 350, 450, 550, 650 may also protect valve train module components such as valves, pressure transducers, solenoids, and electrical components from harsh environmental conditions.

An advantage of the stack formation is that it reduces potential leak points in the valve train system. It is also more portable, reduces the risk of losing parts during repair or installation, and reduces the risk of poor or improper installation due to human error.

Another unique feature of the valve train system of the present invention is the internal integration of functions and features within and between the valve train modules 100, 200, 300, 400, 500, 600. The valve train system of the present invention may include internally integrated fuel and pressure channels, an integrated valve proving system, integrated solenoid actuation of safety shut-off valves, integrated venting, and integrated electrical connections among other integrated functions or features. The internal integration of valve train functions and features reduces the number of external parts which have to be independently configured and fitted for the valve train. It also reduces the number of external parts that may be exposed to harsh environmental conditions or that are required to be manufactured independently with safety features in order to meet various safety regulations or requirements, thus reducing overall maintenance and manufacturing costs associated with the valve train system.

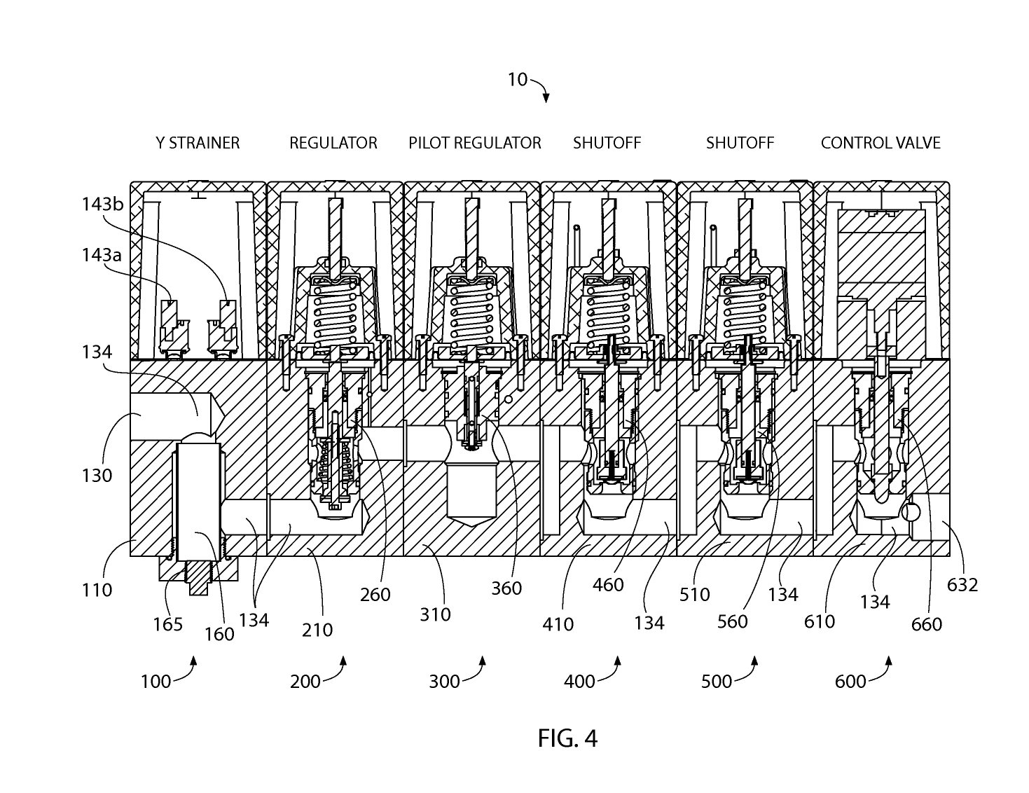

As shown in FIG. 4, fuel intended for delivery to a burner may be channeled through the integrated valve train 10 by way of an internally integrated fuel channel extending through the manifold blocks of the various sequentially connected valve train modules 100, 200, 300, 400, 500, 600. In a preferred embodiment, a fuel inlet source, such as a natural gas pipe, may be connected to a first end of the integrated valve train 10 at a fuel inlet port 130 of a first upstream valve train module 100. The initial valve train module in the sequence of valve stream modules may be a Y-strainer module 100 having a manifold block operably housing a fuel strainer. Fuel transferred into the Y-strainer manifold block 110 may be filtered using a Y-strainer or other fuel straining device 160 to remove contaminants.

After fuel passes through the Y-strainer, fuel may be directed through subsequent valve train manifold blocks configured for other functions of the valve train system. In one embodiment of the present invention, valve train modules downstream from the Y-strainer module 110 may include a main pressure regulator module 200, a pilot regulator module 300, a series of two shut-off valve modules 400, 500, and a control valve module 600. As shown in FIG. 4, each of the manifold blocks 110, 210, 310, 410, 510, 610 of the integrated valve train 10 downstream from the Y-strainer module 100 may have a manifold configured for receive and operably housing a self-contained top loading valve cartridge such as, respectively, a regulator, a pilot regulator, a safety shut-off valve, and a control valve. As used herein, the main regulator is sometimes referred to simply as a regulator and the pilot regulator is generally referred to as the pilot regulator so as to differentiate between the main pressure regulator valve and the pilot pressure regulator valve.

Fuel traveling through the integrated valve train 10 may be directed from the valve train at a fuel egress 632 at the downstream side of an end valve train module in the sequence of valve train modules 100, 200, 300, 400, 500, 600 and then to a burner of a combustion application.

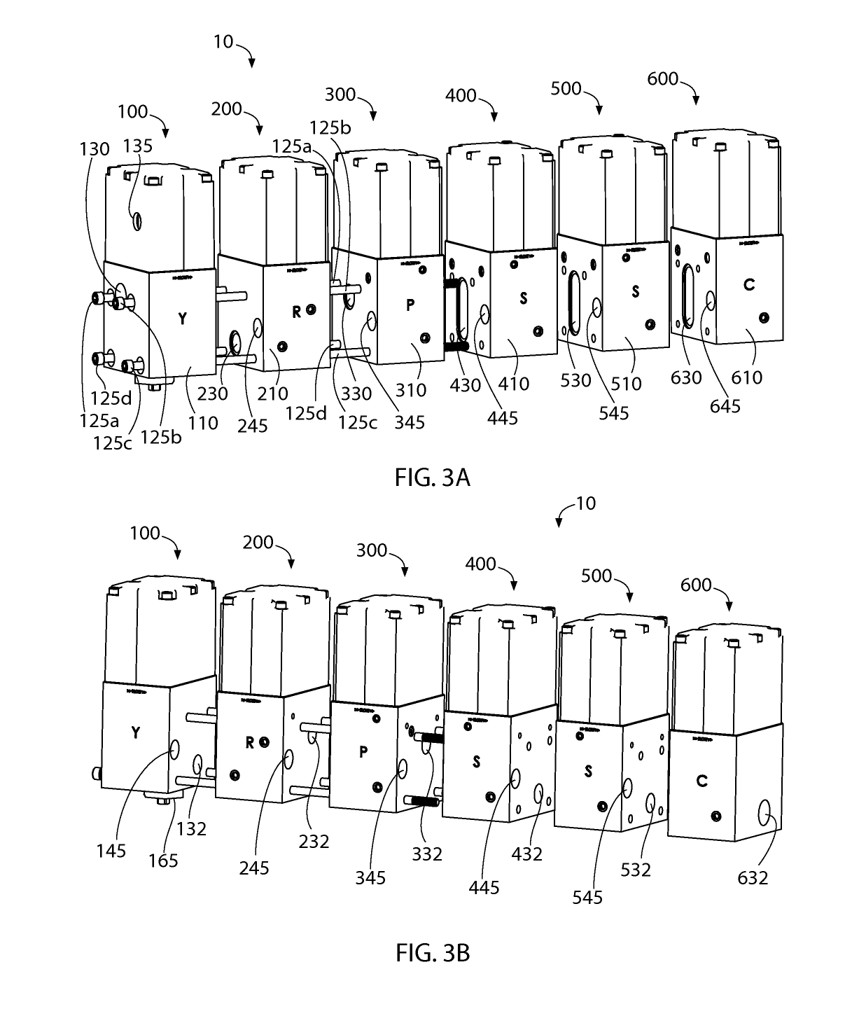

Referring now to FIGS. 3A through 4, the inlet ports 130, 230, 330, 430, 530, 630 and outlet ports 132, 232, 332, 432, 532, 632 of the internally integrated main fuel channel 134 for each of the valve train modules 100, 200, 300, 400, 500, 600 may be seen. The internally integrated main fuel channel 134 may be configured so that a main fuel channel outlet on an upstream valve train module will align with a main fuel channel inlet on a downstream valve train module to allow the receiving and transfer of fuel. As seen in the Figures, valve train manifold blocks 400, 500, 600 may be configured with an elongated vertical port 430, 530, 630 with arched top and bottom ends to permit connection with an offset main fuel channel outlet on a preceding upstream valve train module. If the main fuel channel outlet of an upstream valve train manifold block is offset from the initial axial path of the fuel channel 134 of the subsequent downstream manifold block, the elongated port may act as a vertical channel to direct fuel from the upstream main fuel channel outlet into the main fuel channel of the downstream valve train manifold block. The vertical channels ports 430, 530, 630 may be configured with a seal ring to prevent fuel leaks between manifold blocks when the valve train modules are secured together in a stack formation. An advantage of the vertical channel port configuration is that it permits increased modification of the valve train configuration by allowing interchanging valve train modules with differing functions despite potential offsets in alignment of the internally integrated main fuel channel 134.

It should be understood that the vertical channel ports and seals could also be configured as outlet ports on the downstream side of the valve manifold blocks for connecting with a circular inlet port on an upstream side of a downstream manifold block without departing from the scope of the invention.

As shown in the Figures, the solenoid and pilot fuel channels may also connect between manifold blocks and may have O-rings disposed around their respective perimeters for creating a seal to prevent fuel from leaking between manifold blocks when they are secured to each other.

In an embodiment of the present invention, after fuel is filtered by the Y-strainer 160 it is directed into a main pressure regulator manifold block 210 that has a main pressure regulator 260 operably disposed therein. The main pressure regulator may be used to maintain fuel pressure at a level appropriate for delivery to the burner unit. In an embodiment of the present invention, the main regulator may adjust the fuel pressure to between about 10 psi and about 30 psi. In a preferred embodiment the fuel pressure may be regulated by the main regulator to about 15 psi to about 20 psi. The fuel then travels through the subsequent manifolds of the integrated valve train until directed from the valve train 10 to a burner of an appropriate combustion application.

After fuel pressure is adjusted by the main regulator, it may be directed to various fuel ports of the integrated valve train system 10. Some of the pressure regulated fuel may be diverted to a burner fuel channel and directed through a series of safety shut-off valves 460, 560 and a control valve 660 and ultimately exiting the valve train for delivery to a burner unit.

Some of the pressure regulated fuel may also be diverted and transferred to a pilot pressure regulator 360 where the pressure is further regulated and then travels through subsequent valve train manifolds through integrated pilot fuel ports or channels ultimately exiting the valve train for delivery to a pilot. In a preferred embodiment, pilot fuel is regulated at the pilot regulator module 300 to about 5 psi.

Another unique feature of the present invention is a method of operating valves using small solenoids that may control flow of regulated fuel diverted by at a regulator module. Some of the fuel regulated by the main pressure regulator 360 may be diverted and transferred through a solenoid fuel port from where it may travel through subsequent valve train manifolds through integrated solenoid fuel pressure channels to solenoid ports where solenoids disposed in various manifolds of the valve train 10 may control the flow and venting of fuel.

Fuel may also be directed from the regulator manifold block 210 to the pilot regulator manifold block 310. In an embodiment of the present invention, fuel diverted from the burner fuel line to the solenoid and pilot fuel channels after being regulated by the main regulator are diverted in the manifold block 210 of the regulator valve train module 200. In another embodiment of the present invention, fuel diverted from the burner fuel line to the solenoid and pilot fuel ports after being regulated by the main regulator are diverted in the manifold block 310 of the pilot regulator valve train module 300.

Fuel diverted to the pilot fuel pressure channel may travel from the pilot fuel line through a pilot regulator 360 for maintaining fuel pressure at an appropriate level for delivery to a pilot. In a preferred embodiment of the present invention, the pilot regulator may adjust the pilot fuel pressure to about 5 psi. After fuel pressure is regulated by the pilot regulator, it may travel through the pilot fuel channels of the pilot manifold block 310 and be transferred to the pilot fuel channels of a subsequent integrated valve train manifold block 410, 510, 610.

Other downstream manifold blocks in the integrated valve train 10, such as one or more safety shut-off valve manifold blocks 410, 510, a control valve manifold block 510, or another regulator manifold block 200, may also be configured with integrated pilot fuel channels for receiving fuel from the integrated pilot fuel channels of upstream manifold blocks in the valve train 10. Fuel transferred through the internally integrated pilot fuel channels may travel through the entire valve train until exiting for delivery to a pilot or be redirected to the internally integrated main fuel burner line for use in a slip-stream configuration. In a slip-stream pilot system, the fuel may ultimately be delivered from the main regulator end of the integrated valve system to a combined pilot/burner unit.

Fuel diverted to the solenoid fuel pressure channel may be used for operating solenoids in various manifolds within the integrated valve train. Each of the manifold blocks in the integrated valve train 10 may also be configured with solenoid ports or lines for receiving fuel from the solenoid fuel pressure channels of upstream valve train manifold blocks to permit integration of solenoid fuel channels between manifolds blocks. Fuel pressure within the solenoid fuel channels may be regulated by the main pressure regulator and maintained at about 15 psi.

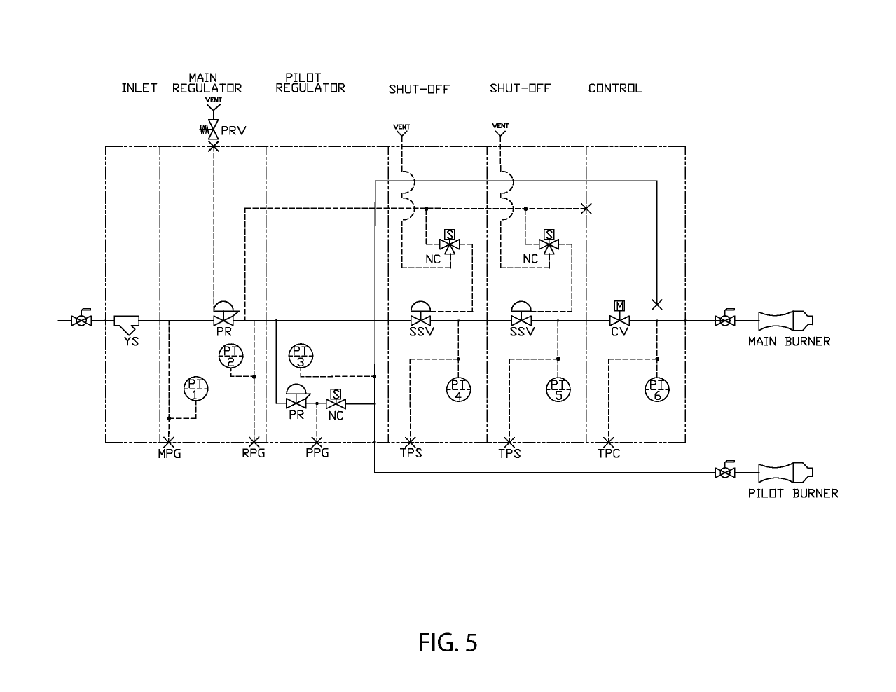

Turning now to FIGS. 5 through 8, schematics are provided of exemplary embodiments of the integrated valve train systems showing various configurations of integrated fuel and pressure channels, an integrated valve proving system, integrated actuation of solenoids, integrated venting, and pilot configurations in accordance with one or more aspects of the present invention. As can be seen from the Figures, the system of internally integrated fuel channels of valve train system 10 may include a unique configuration of external and internal plugs for fuel channels and fuel ports which may be removed or inserted in order to change the valve train configuration in accordance with one or more aspects with the present invention. The plugs may be removed to use pressure test ports, such as a safety shut-off valve test port (TPS) or a control valve test port (TPC). The plugs may also be removed to permit operably connecting a main pressure gauge (MPG), a regulator pressure gauge (RPG), a pilot pressure gauge (PPG), or a pressure relief valve (PRV). As shown in the figures, various plugs may also be removed from or inserted into ports in the manifold blocks of the valve train 10 in order to connect a standard external pilot or to configure the valve train 10 for slip-stream functionality. The plugs may be threaded plugs that can be inserted and remove by screwing them in and out of threaded ports.

An advantage of the unique configuration of fuel channels and fuel channel plugs is that it allows a person to quickly and easily modify the valve train 10 between a standard external pilot configuration and a slip-stream configuration. An advantage of the unique configuration of fuel channels and fuel channel plugs is that it allows a person to quickly and easily modify the valve train 10 between a vent configuration wherein valve train module sections are vented by section and a vent configuration wherein valve train module sections are vented using a common vent.

As shown in FIG. 5, an integrated valve train system 10 is provided wherein the valve train is configured with an external pilot and the regulator module 200 and a series of safety shut-off valve modules 400, 500 are independently vented from the respective module sections.

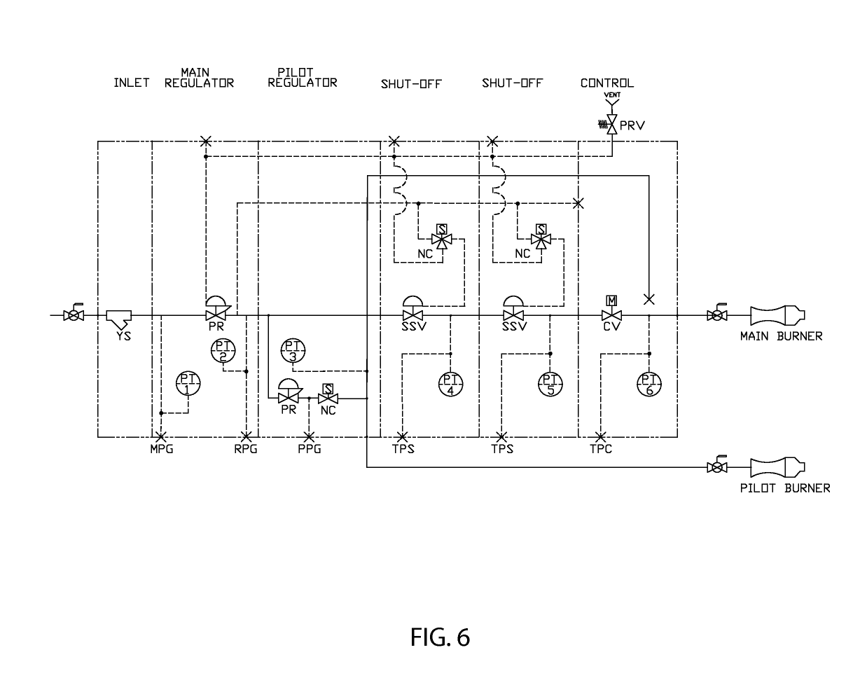

As shown in FIG. 6, an integrated valve train system 10 is provided wherein the valve train 10 is configured with an external pilot and the regulator module 200 and a series of safety shut-off valve modules 400, 500 are vented through a common vent port.

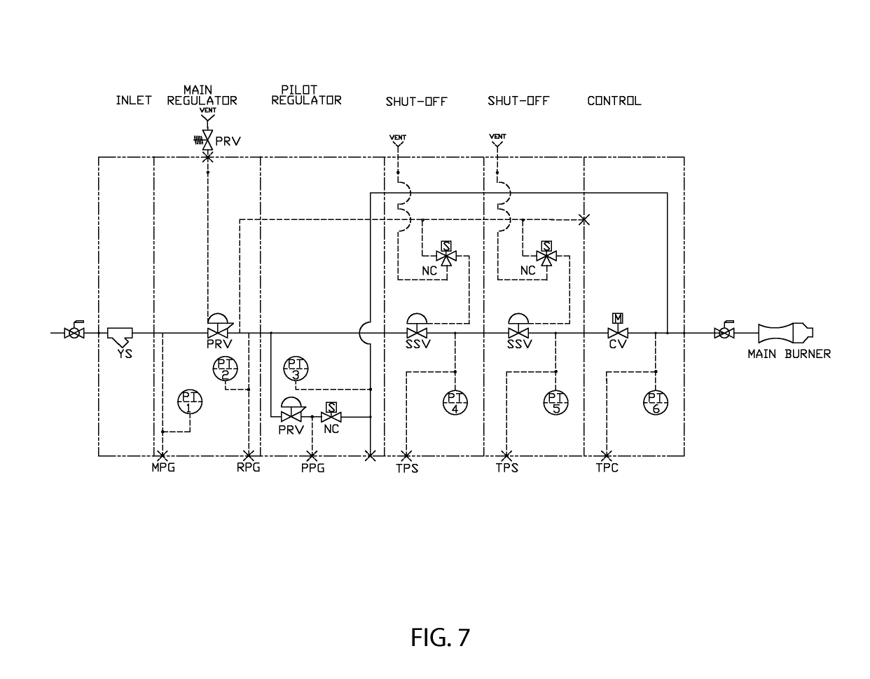

As shown in FIG. 7, an integrated valve train system 10 is provided wherein the valve train 10 is configured for internally integrated slip-stream functionality and the regulator module 200 and a series of safety shut-off valve modules 400, 500 are independently vented from the respective module sections.

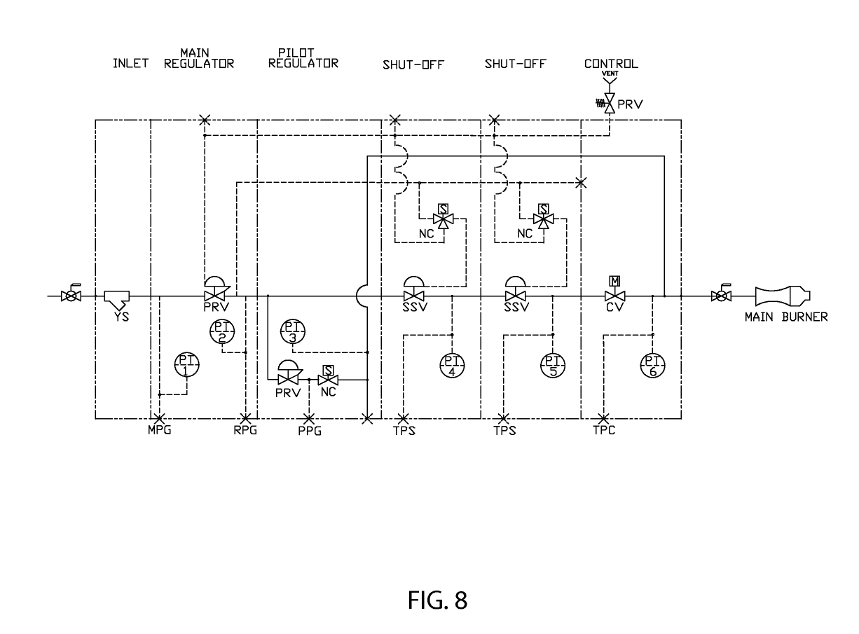

As shown in FIG. 8, an integrated valve train system 10 is provided wherein the valve train 10 is configured for internally integrated slip-stream functionality and the regulator module 200 and a series of safety shut-off valve modules 400, 500 may be vented through a common vent port.

In a slip-stream configuration, a burner may function as a combined burner and pilot. During ignition, gas regulated by the main regulator may be stopped at the safety shut-off valves and prevented from traveling from the valve train 10 through the internally integrated main fuel channel 134. Gas diverted from the internally integrated main fuel channel 134 to the pilot regulator may be regulated to a lower pressure and diverted through pilot fuel channels disposed in the valve train manifold blocks where it may be channeled back into the main fuel line in a valve train module, such as a control valve module 600, positioned in the valve train stack downstream from the safety shut-off valve modules 400, 500. Fuel can then be directed to the burner at a lower fuel pressure for initial ignition. This allows the burner to be safely ignited using a lower fuel pressure before gas diverted from the regulator into the main fuel channel is directed to the burner at a higher pressure for greater combustion. In a preferred embodiment, fuel pressure directed from the pilot regulator through the pilot fuel channel to the main line for initial ignition of the burner is regulated to about 5 psi.

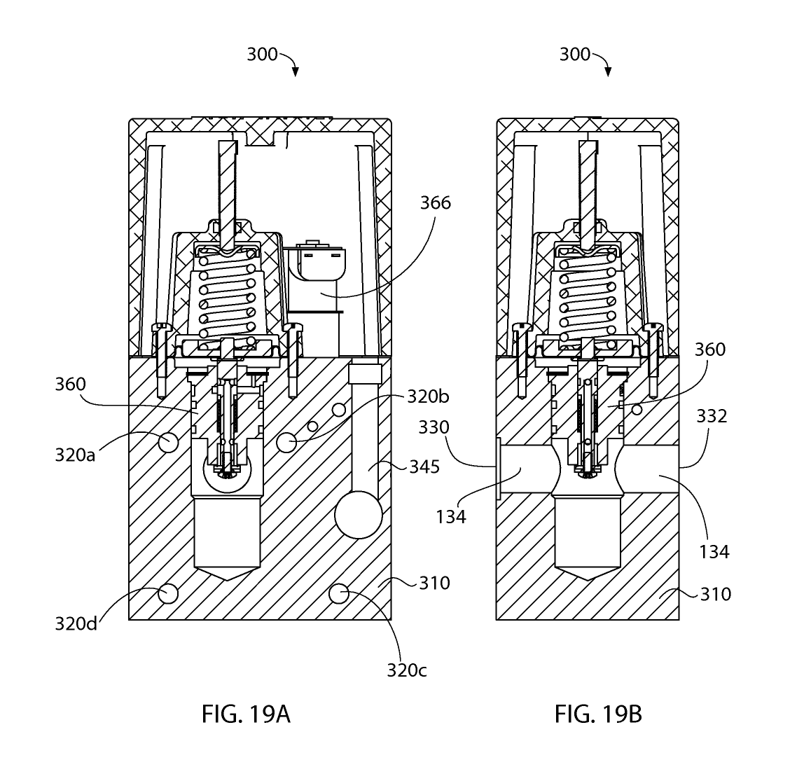

As can also be seen from FIGS. 5 through 8, a unique integration of the valve train system throughout the valve train system and between valve train modules 100, 200, 300, 400, 500, 600 is provided. As can also be seen from the Figures, novel integration of functions within individual valve train modules is provided. In an embodiment of the present invention, a pilot regulator valve module 300 is provided wherein safety shut-off functionality is integrated with a pilot regulator within a single control valve module 300. As seen in FIGS. 5 through 8 and FIGS. 18 to 20, the pilot regulator module 300 may comprise a pilot regulator manifold block 310 configured with a pilot regulator manifold 362 for receiving and operably housing a self-contained top loading pilot regulator valve 360. The pilot regulator module may also include a two-way solenoid 366 disposed within a solenoid port on a top side of the manifold block 310 and operably connected with an integrated pilot fuel channel. Fuel directed to the pilot regulator 360 may be regulated down for pilot ignition of the burner. The two-way solenoid 366 may be disposed downstream from the pilot regulator valve 360, but within the pilot regulator module, and acts as a safety shut-off valve to stop pilot fuel flow in response to communications from a control box or burner management system. Electronic components of the pilot regulator module 300, such as a pressure transducer 365 and the two-way solenoid 366 may be protected under an explosion-proof housing cover 350 which may be secured to a top side of the pilot regulator manifold block 310 using elongated bolts 355a, 355b, 355c, 355d, 355e, 355f which may screw into threaded holes in the top side of the pilot regulator manifold block 310. One of the advantages to integration of the pilot regulator and pilot safety shut-off functions within a single valve train module is that it increases safety by reducing leak paths. It also reduces the number of valve train components that must be assembled on-site and reduces assembly and maintenance time and costs.

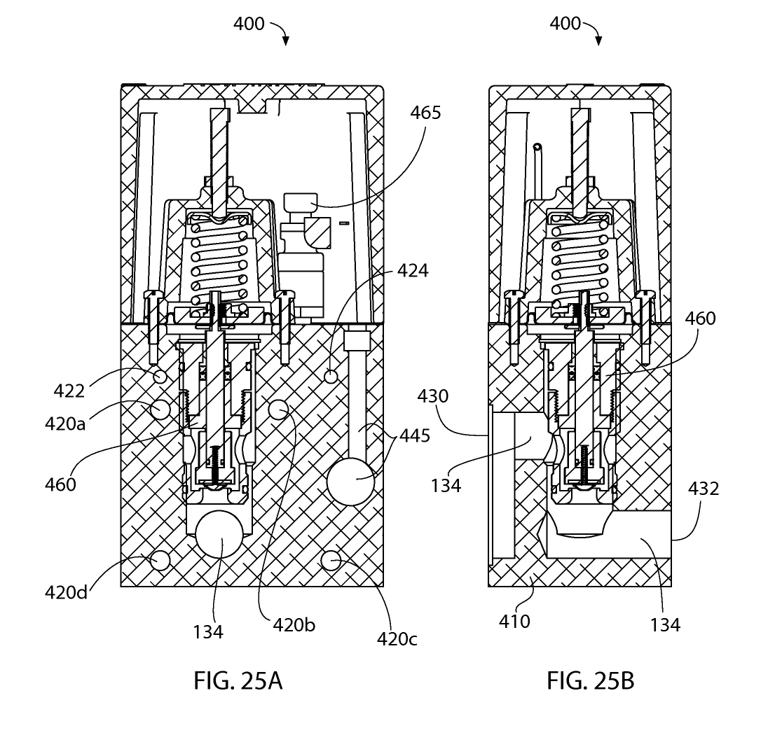

Another unique aspect of the present invention is integration of solenoid actuation of safety shut-off valves for the main fuel channel. As seen in FIGS. 5 through 8 and FIGS. 24 to 26, the safety shut-off valve module 400 may comprise a shut-off valve manifold block 410 having a valve manifold 462 configured for receiving and operably housing a self-contained top loading safety shut-off valve 460, a self-contained top loading safety shut-off valve 460 disposed in the safety shut-off valve manifold 462, integrated burner fuel and pressure channels and test ports internally disposed within the shut-off valve manifold block 410, a pressure transducer 465 disposed in a transducer port that is connected to pressure channels for valve proving, and a three-way solenoid 466 disposed in a solenoid port connected to fuel channels for actuating the safety shut-off valves.

The three-way solenoid 466 may receive communications from a control box or burner management system to open, close or redirect gas flow and may be used to open or close an integrated gas channel diverted from the main gas channel at the main regulator module 200, as shown in FIGS. 5 through 8. The three-way solenoid 466 may actuate the safety shut-off valve by directing gas under the diaphragm of the safety shut-off valve and by opening ports to allow release of gas from the under the diaphragm. The gas can then be vented from an integrated vent within the shut-off valve module 400 or through a common vent at the control valve module 600. The three-way solenoid 466 and safety shut-off valve are integrated within the same valve train module 400. An advantage of integrating the solenoid and safety shut-off functions within a single valve train module is that it increases safety by reducing leak paths. It also reduces the number of valve train components that must be assembled on-site and reduces assembly and maintenance time and costs.

Electronic components of the safety shut-off valve module 400, such as a pressure transducer 465 and the three-way solenoid 466 may be protected under an explosion-proof housing cover 450 that may be secured to a top side of the shut-off valve manifold block 410 using elongated bolts 455a, 455b, 455c, 455d, 455e, 455f which may screw into threaded holes in the top side of the pilot regulator manifold block 410.

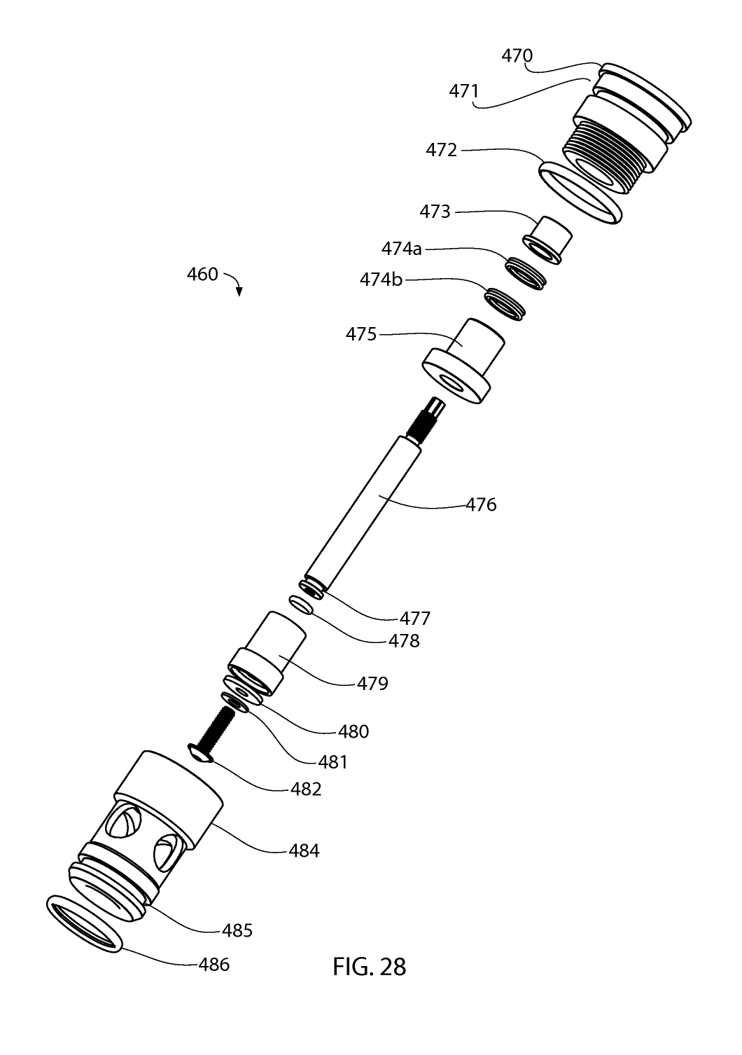

It should be understood that the downstream safety shut-off valve module 500 shown in FIG. 1 and other Figures has the same components as the upstream safety shut-off valve module 400 as shown in FIGS. 1 through 3B and FIGS. 24 through 29. However, it should also be understood that the upstream safety shut-off valve module 400 and the downstream safety shut-off valve module 500 may be configured differently such as by removal or insertion of fuel channel plugs for connection of test equipment, gauges, release valves, opening of vents, or modifying fuel paths in accordance with one or more aspects of the present invention.

As may also be seen from FIGS. 5 through 8, another unique aspect of the present invention is an internally integrated valve proving system. The integrated valve proving system of the present invention provides a method for ensuring that valves, such as the safety shut-off valves (SSVs), are closed and no fuel or gas has leaked into the burner prior to ignition. The valve proving system may also be used to detect leaks between valve train modules and other potential leak points in the valve train system 10.

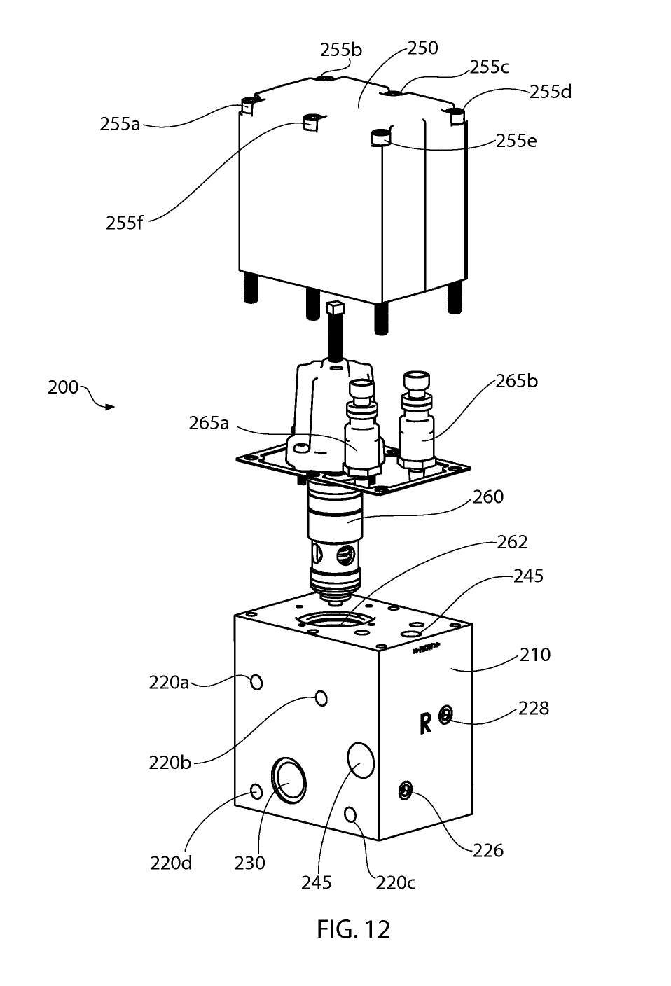

As shown in FIGS. 12, 18, 24, and 30, electronic sensors, such as pressure transducers 265a, 265b, 365, 465, 665, may be disposed in the manifold blocks 200, 300, 400, 500, 600 in ports connected with fuel channels for sensing pressure changes and for testing for leaks in the valve train 10. The pressure transducers 265a, 265b, 365, 465, 665 may be connected to a control box or burner management system for communication of data between the pressure transducers 265a, 265b, 365, 465, 665 and the control box. The integrated valve proving system of the present invention may include internal and integrable fuel lines for testing for fuel leaks.

Thus, an advantage of the integrated valve proving system of the present invention is that it may permit valve proving without the need for external bypass valves or running a valve proving system externally in parallel with the valve train, eliminating need for separate configuration of the valve proving system. It also reduces potential leak paths that may be introduced by external bypasses.

Another advantage of the integrated valve proving system of the present invention is that fewer components are needed to operate the valve proving system. Also, integrated electronic components of the valve proving system may be protected under the explosion-proof housing covers of the valve train modules. Schematics of exemplary configurations of the integrated valve proving system of the present invention may be seen in FIGS. 5 through 8.

As seen in the Figures, the integrated valve proving system may use internal integral pressure transducers PT1, PT2, PT3, PT4, PT5, PT6 to monitor the fuel pressure in fuel and pressure channels and between valves. In one embodiment of the invention, the upstream safety shut-off valve (SSV) may be proved closed by monitoring the pressure at PT4 while the downstream SSV is closed and verifying that there is no pressure increase over a prescribed amount of time. The upstream SSV may then be opened allowing the pressure between PT2 and PT4 to equalize. The upstream SSV will then be closed and the downstream SSV may be proved closed by monitoring the pressure at PT4 and verifying that there is no pressure degradation over a prescribed amount of time.

In accordance with another aspect of the present invention, the integrated valve proving system may be automated using a burner management system or control box connected to the electrical components of integrated valve proving system through a novel internally integrated electrical system of the valve train 10. The control box may send and receive communications for operation of the integrated valve proving system and other electronically controlled features of the integrated valve train 10 through the unique internally integrated electrical system of the valve train 10.

One of the advantages of the internally integrated electrical system of the present invention is that it provides for single point connection of electrical features of the valve train. Another advantage is that it eliminates or reduces external wiring of electronic components of the valve train system and reduces wear and tear on the system by reducing exposure to potentially harsh environmental conditions. Connection points with transducers and other electronic components, such as solenoids, may be easily maintained within the explosion proof valve train module housing covers 150, 250, 350, 450, 550, 650.

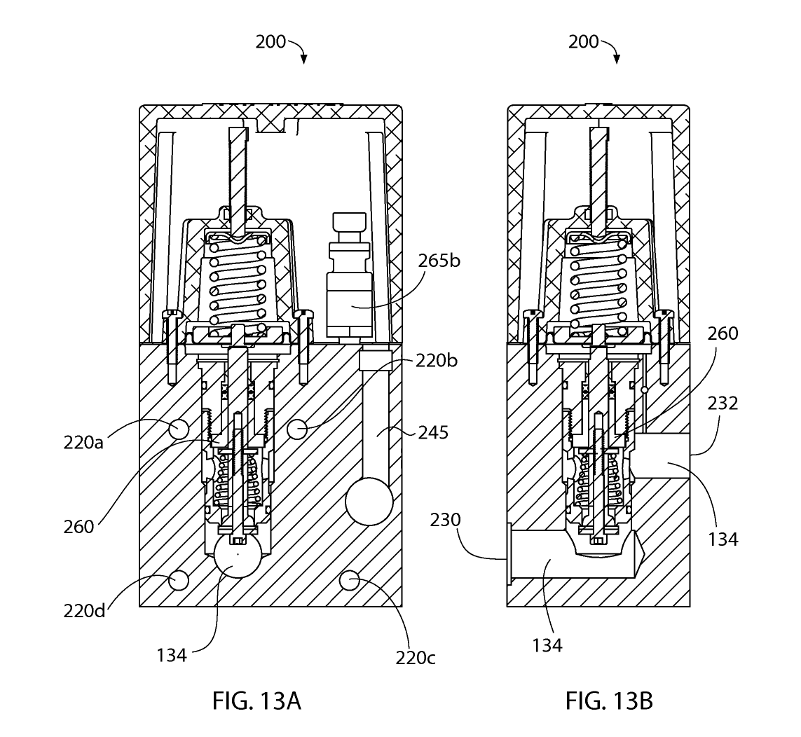

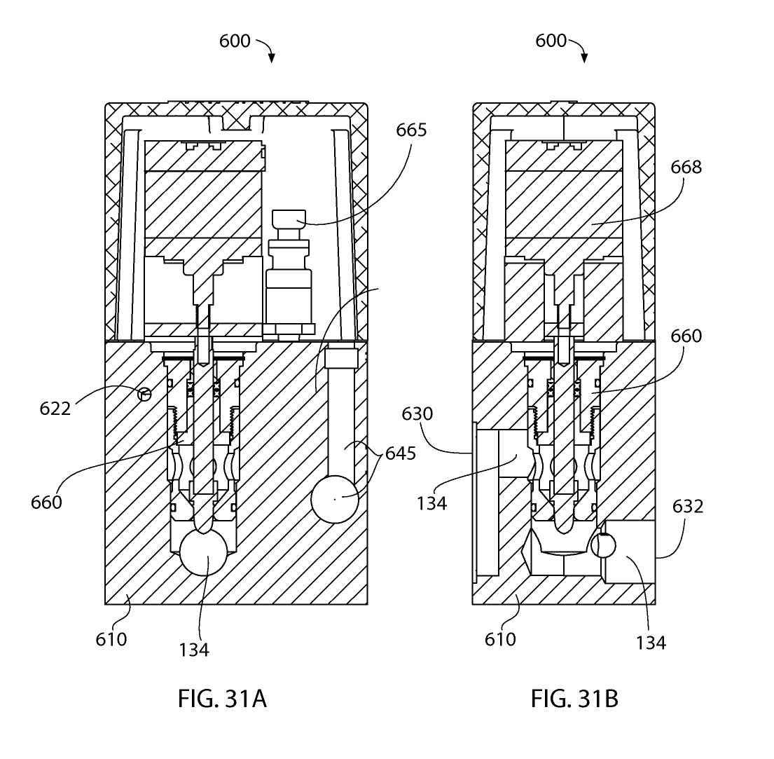

As shown in FIGS. 3A, 3B, 9, 10A, 12, 13A, 18, 19A, 24, 25A, 30, and 31A, each of manifold blocks 110, 210, 310, 410, 510, 610 of the respective valve train modules 100, 200, 300, 400, 500, 600 may have an internal electrical port 145, 245, 345, 445, 545, 645 that may connect and internally integrate with the electrical ports of other manifold blocks when the valve train modules 100, 200, 300, 400, 500, 600 are connected and configured in a stack formation as shown in FIG. 1. The electrical ports may be configured to connect with the electrical ports of other manifold blocks of the integrated valve train 10, permitting the electrical system to be integrated between valve train modules.

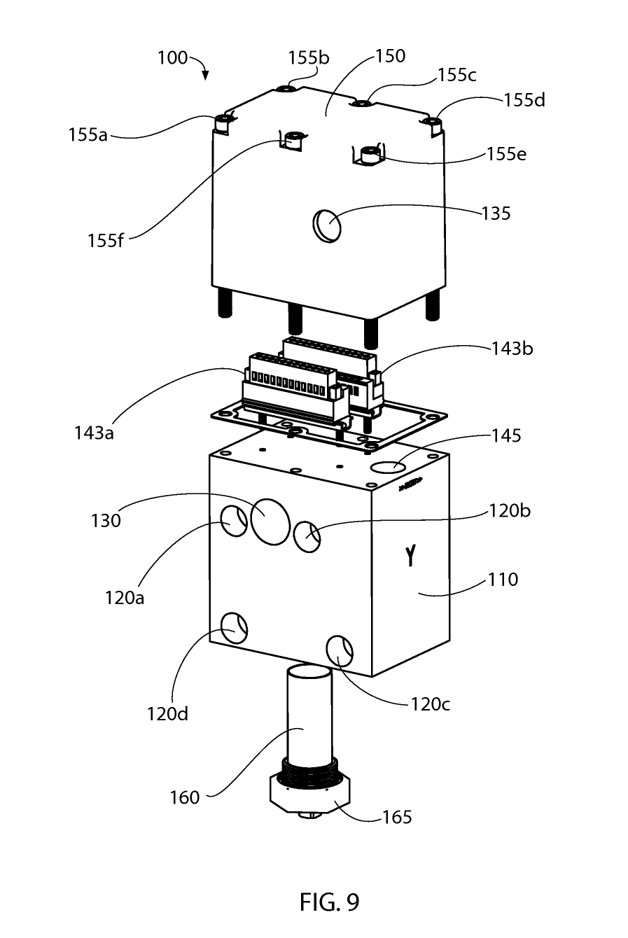

In an embodiment of the present invention, the integrated electrical system of the valve train 10 may provide for a single point connection at a first upstream valve train module 100. Referring now to FIG. 9, electrical connections such as those from a control box may be passed through an electrical port 135 on the explosion-proof housing 150 of said first upstream valve train module 100. The electrical wiring can be connected to terminal blocks 143a, 143b mounted on a top side of the manifold block 110 of the valve train module. The terminal connections may be protected due to being enclosed under the explosion-proof housing 150. All of the wiring for electrical connections for the valve train 10 may then be passed through the sequential manifold blocks 110, 210, 310, 410, 510, 610 by way of the respective internally integrated electrical ports or passages 145, 245, 345, 445, 545, 645. Thus, the integrated electrical wiring passage connects between valve train modules when the valve train 10 is connected in a stack configuration.

The electrical passages 145, 245, 345, 445, 545, 645 may also include a top entry electrical port extending to and porting open on a top side of each of the manifold blocks 110, 210, 310, 410, 510, 610 to permit electrical wiring into the valve train modules to connect with electronic components such as pressure transducers and solenoids on a top side of the respective valve train manifold blocks 110, 210, 310, 410, 510, 610 so they may be enclosed under the respective explosion-proof housings 150, 250, 350, 450, 550, 650. Thus, the electrical connections may all be protected and maintained from adverse events and environmental conditions internally within the valve train modules. Top entry electrical ports permit integrating the electrical functions of the various valve train modules within the integrated valve train system.

Another advantage of the internally integrated electrical system of the valve train of the present invention is that the reduced number of connections reduces maintenance time because less connection points that may need repairs. Also, the close proximity of the connections and portability of the valve train system means that less time and resources will be required to access the electrical system for repairs.

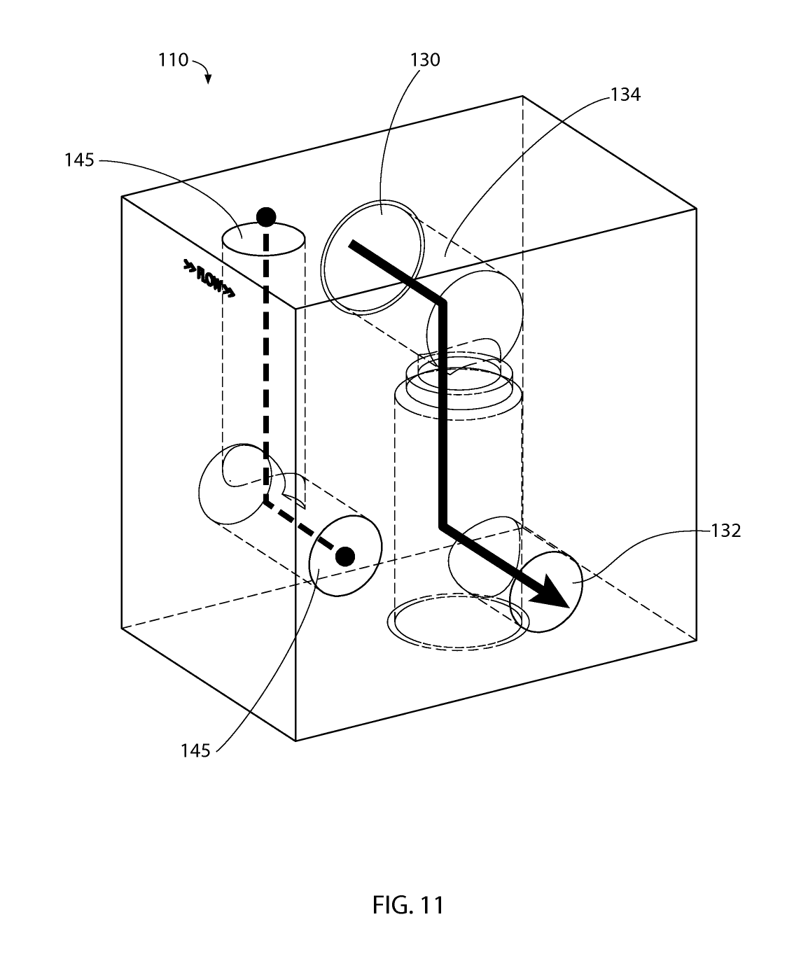

Turning now to FIGS. 9 through 35, embodiments of the various valve train modules 100, 200, 300, 400, 500, 600 in accordance with one or more aspects of the present invention.

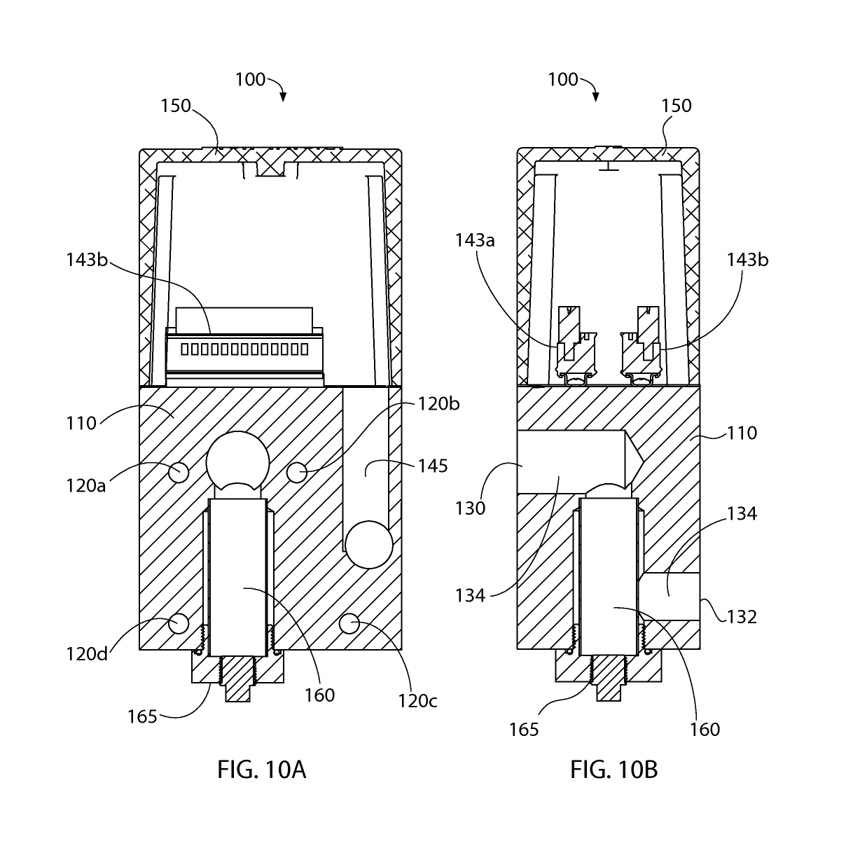

As shown in FIGS. 9 through 11, a Y-strainer module 100 is shown in accordance with one or more aspects of the present invention. As seen in FIGS. 9, 10A and 10B, the Y-strainer module 100 may be comprised of a Y-strainer manifold block 110 configured with a main fuel channel 134 having a fuel inlet port 132 at an upstream side of the manifold block and a strainer screen manifold for receiving a fuel strainer screen 160 on a bottom side of the manifold block 110. The main fuel channel 134 passes through the strainer screen manifold. The strainer screen 160 may have a clean-out plug 165 at a bottom end. The clean-out plug 165 and the strainer screen manifold may be threaded so that the clean-out plug may be threaded into the strainer screen manifold to secure the strainer screen 160 in the strainer screen manifold by turning. Fuel passing through the main fuel channel 134 in the Y-strainer module 100 may be filtered as it passes through the strainer screen to remove contaminants.

The Y-strainer module 100 may include terminal blocks 143a, 143b secured on the top side of the manifold block 110 and an electrical wire port 145 for integration of the valve train electrical system. An explosion-proof housing cover 150 may be secured on top of the manifold block 110 using threaded bolts 155a, 155b, 155c, 155d, 155e, 155f. The explosion-proof housing 150 also includes an electrical port 135 to permit wires from a control box or a power source to be extended into the housing cover 150 for connection to the electrical terminal blocks 143a, 143b. Tie rod holes 120a, 120b, 120c, 120d may also be provided in the Y-strainer manifold block for receiving tie rods used to secure the valve train 10 in a stacked formation.

Turning now to FIGS. 12 through 17, a main regulator module 200 is disclosed in accordance with one or more aspects of the present invention. As shown in the Figures, the main regulator module may be comprised of a regulator manifold block 210, a self-contained top-loading regulator valve cartridge 260, a first and second pressure transducer 265a, 265b, and an explosion-proof housing cover 250 which may be secured on top the manifold block 210 using threaded bolts 255a, 255b, 255c, 255d, 255e, 255f.

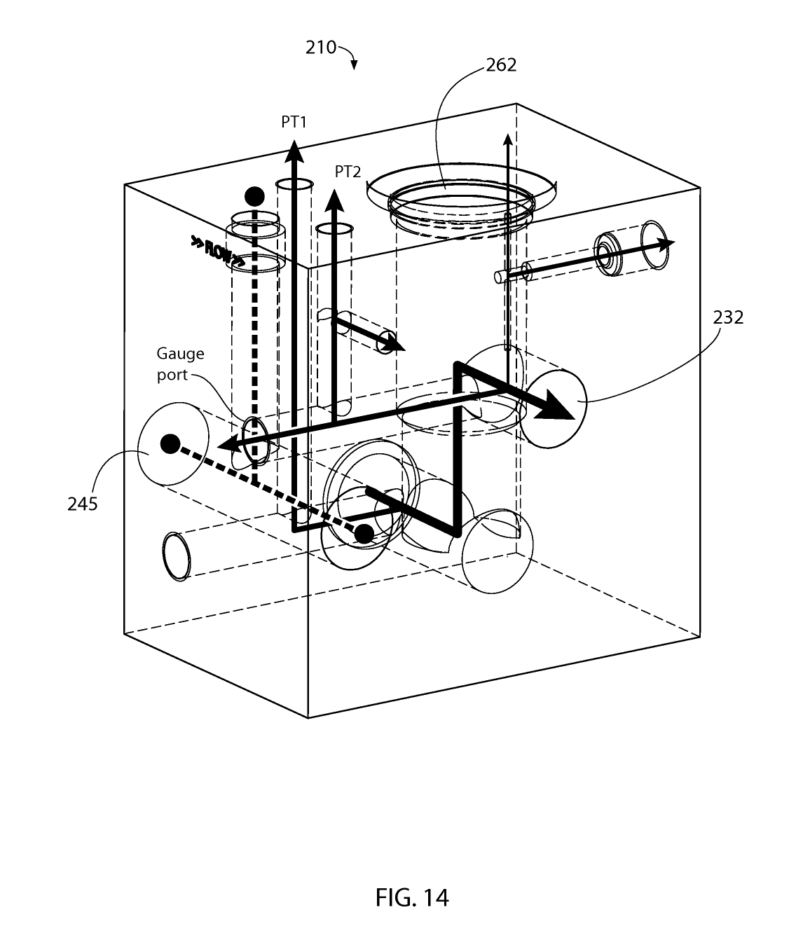

The regulator manifold block 210 may have a regulator manifold 262 for receiving and operably housing the regulator cartridge 260. The self-contained top loading regulator cartridge 260 may be secured in the regulator manifold 262 using a snap ring. The pressure transducers 265a, 265b may be operably connected to respective transducer ports shown in FIG. 14. The regulator manifold block may also include a main fuel channel 134, a main fuel channel inlet port 230 and outlet port 232, pressure transducer fuel channels, and a gauge port. The regulator module 200 may include an electrical wire port 145 extending axially and vertically for integration of the valve train electrical system. Tie rod holes 120a, 120b, 120c, 120d may also be provided in the manifold block 210 for receiving tie rods used to secure the valve train 10 in a stacked formation.

The regulator module 200 may be used to regulate fuel pressure in the main fuel line. Fuel regulated at the regulator module 200 may also be diverted to the pilot regulator for further down regulation of fuel pressure.

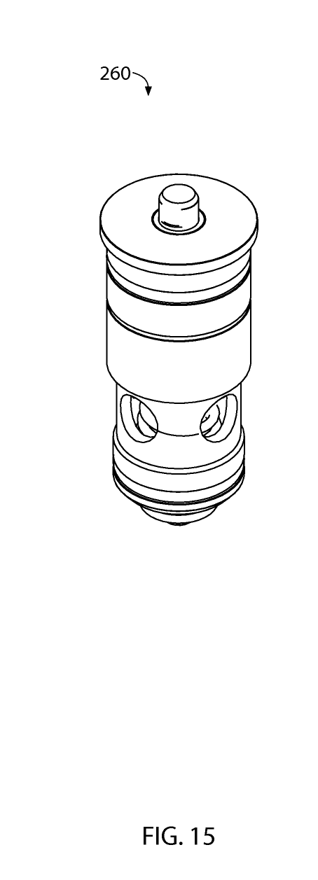

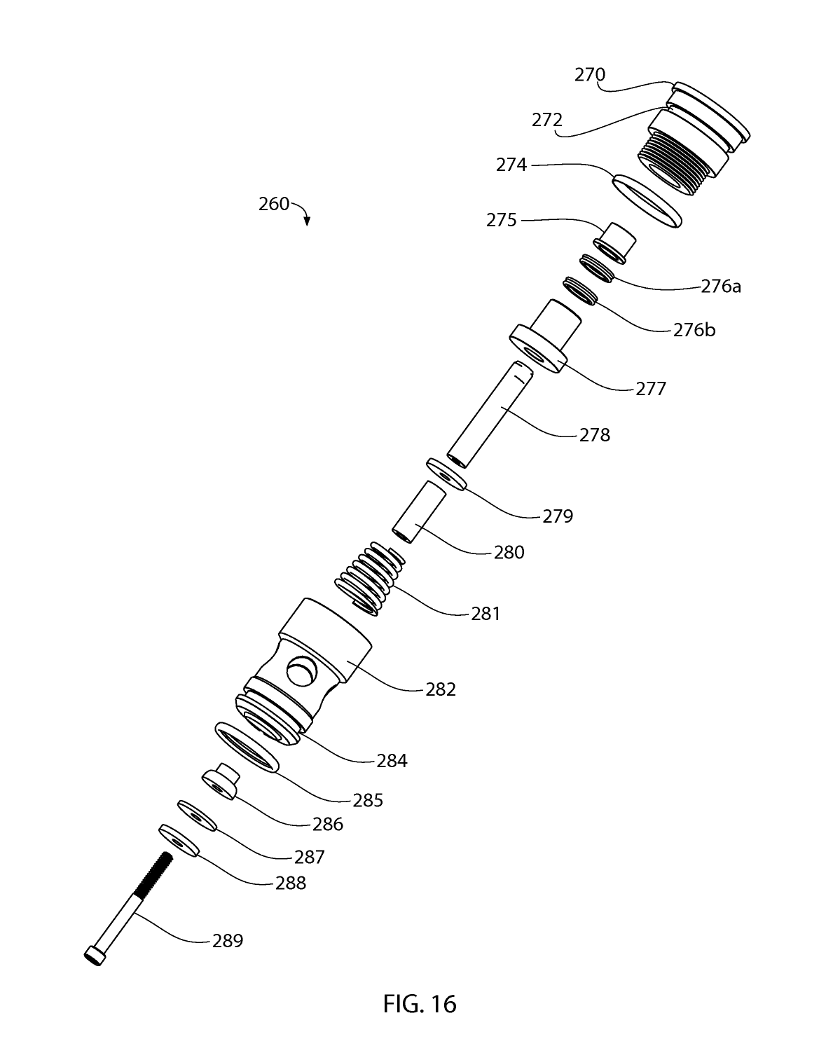

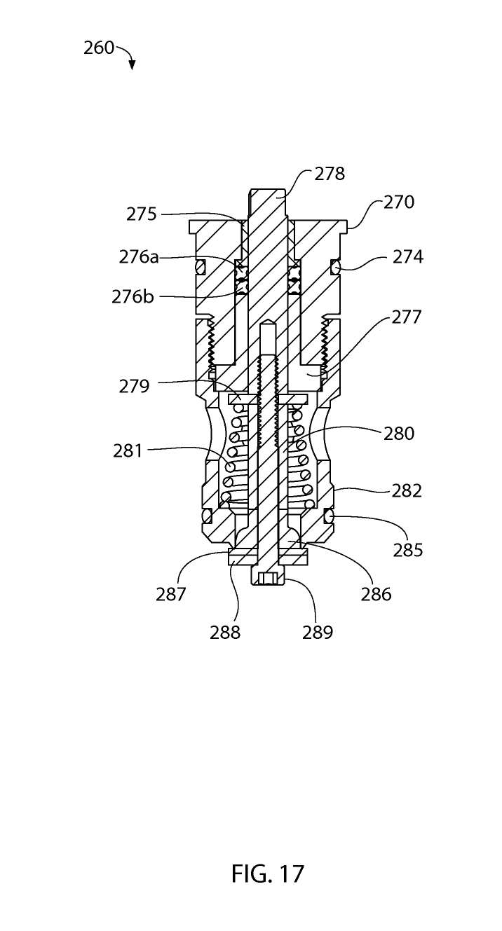

Referring now to FIGS. 15 through 17, a regulator valve 260 in accordance with one or more aspects of the present invention is shown. As can be seen in the Figures, the regulator valve 260 is a self-contained cartridge configured for top loading into the regulator manifold block 210. As shown in FIGS. 16 and 17, the regulator valve 260 may be comprised of a bonnet cartridge 270 having a bonnet seal ring groove 272, a seal ring 274 disposed in the bonnet seal ring groove 272, a stem 278 extended through a stem guide 277, two or more rubber Q-rings 276a, 276b, a stem bushing 275, and through the top center of the bonnet cartridge 270, wherein the two or more rubber Q-rings 276a, 276b are secured between the stem guide 277 and the stem bushing 275 and the stem bushing 275 is disposed in an upper internal cavity of the bonnet cartridge 270. As shown in the Figures, the regulator valve 260 may be further comprised of a seat cartridge 282 having a seat cartridge seal ring groove 284, a seat cartridge seal ring 285 disposed in the seal ring groove 284, an internal regulator spring 281 disposed within the seat cartridge 282, a stem spacer 280 extended through the internal regulator spring 281 and through the center of the seat cartridge 282. A socket head cap screw 289 may be extended through the center of a metal washer 288, a rubber seal gasket 287, a regulator plug 286, the seat cartridge 282, and the stem spacer 280, and a spring washer 279 wherein the socket head cap screw 289 is threaded into the stem 278 and the spring washer 279 is secured between stem spacer 280 and the stem 278 so that the internal regulator spring 281 may load against the spring washer 279.

The bonnet cartridge 270 and the seat cartridge 284 have threaded fittings so that the bonnet cartridge 270 and the seat cartridge 284 may be threaded together to provide a single self-contained valve cartridge wherein the bonnet and seat ring are directly connected.

When assembled the regulator valve cartridge comprises a single self-contained cartridge that may provide regulator functionality when secured in the regulator manifold block 210 in an assembled regulator module 200. The configuration of the regulator valve 260 within the regulator manifold 262 of the regulator manifold block may provide for flow-under functionality. Fuel leaks from pressure around the regulator valve 260 when it is secured in the regulator manifold 262 may be prevented by the seal rings 274, 284 secured around the bonnet cartridge 270 and the seat cartridge 282 which create a seal between the regulator valve cartridge 260 and the regulator manifold block 210.

One of the advantages of connecting the bonnet and the seat directly is that it allows configuration of a self-contained valve. One of the advantages of having a self-contained regulator valve cartridge is that the valve components may be assembled with the valve train modules as a unit rather than separately. This reduces the risk of losing parts and reduces assembly time. Because the regulator cartridges are self-contained, it also ensures alignment of the plugs and the seats which do not need to be adjusted during installation. Also, because fuel pressure around the self-contained top loading valve cartridges 260, 360, 460, 660 is managed within the respective manifold or housing blocks 200, 300, 400, 600, it reduces leak paths. Another advantage is that the valves may be easily installed, removed, and replaced without extensive time and labor costs because the valves are self-contained cartridges.

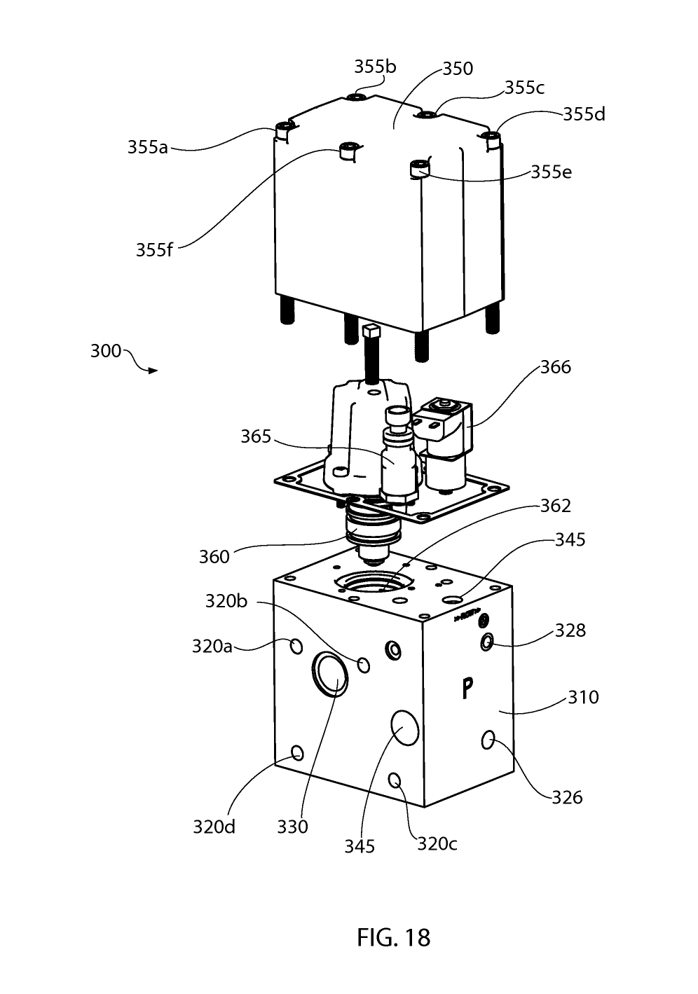

Turning now to FIGS. 18 through 23B, a pilot regulator module 300 is disclosed in accordance with one or more aspects of the present invention. As shown in the Figures, the pilot regulator module 300 may be comprised of a pilot regulator manifold block 310, a self-contained top-loading pilot regulator valve cartridge 360, a pressure transducer 365, a two-way solenoid 366, and an explosion-proof housing cover 350 which may be secured on top the pilot regulator manifold block 310 using threaded bolts 355a, 355b, 355c, 355d, 355e, 355f.

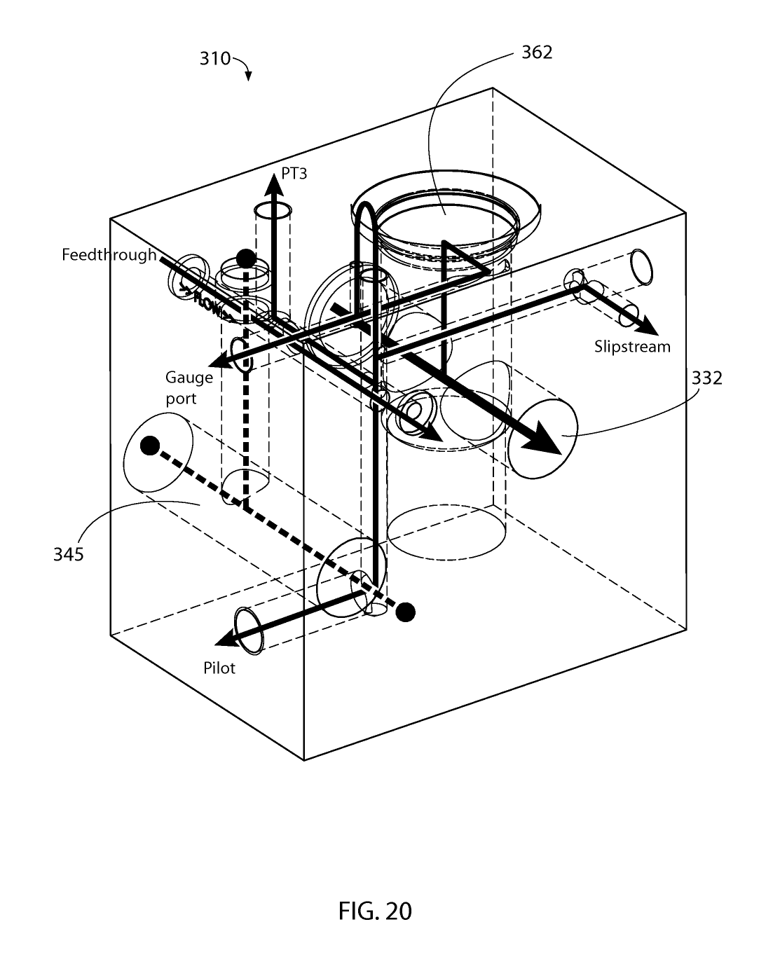

The pilot regulator manifold block 310 may have a pilot regulator manifold 362 for receiving and operably housing the pilot regulator cartridge 360. The self-contained top loading pilot regulator cartridge 360 may be secured in the pilot regulator manifold 362 using a snap ring. The pressure transducer 365 may be operably connected to a transducer port shown in FIG. 20. The pilot regulator manifold block 310 may also include a main fuel channel 134, a main fuel channel inlet port 330 and main fuel channel outlet port 332, a pressure transducer fuel channel, a pilot port 326, and a gauge port 328. The pilot regulator module 300 may include an electrical wire port 345 extending axially and vertically for integration of the valve train electrical system. Tie rod holes 320a, 320b, 320c, 320d may also be provided in the pilot regulator manifold block 310 for receiving tie rods used to secure the valve train 10 in a stacked formation.

The pilot regulator module 300 may be used to regulate pressure of fuel diverted from the internally integrated main fuel line 134 and transferred to the pilot fuel channel. In a preferred embodiment, the pressure is regulated down to about 5 psi. However, it should be understood that the pressure could be regulated to other pressure points without departing from the scope of the invention. Fuel regulated pilot regulator 360 at the pilot regulator module 300 may be diverted to the pilot regulator fuel channel for use in a pilot or a slip-stream. In an external pilot configuration, a threaded plug may be removed from the pilot port 326 and an external pilot may be connected to the pilot port 326 of the pilot regulator module 300 for fueling the external pilot.

In a slip-stream configuration, the threaded plug is securely disposed in the pilot port 326 and internal plug within the control valve module 600 is removed to permit gas to flow through the internally integrated pilot fuel channels and return to the internally integrated main fuel channel 134 within the control valve module as shown in FIGS. 7 and 8.

The two-way solenoid 366 may be disposed downstream from the pilot regulator valve 360, but within the pilot regulator module, and acts as a safety shut-off valve to stop pilot fuel flow in response to communications from a control box or burner management system. One of the advantages to integration of the pilot regulator and pilot safety shut-off functions within a single valve train module is that it increases safety by reducing leak paths. It also reduces the number of valve train components that must be assembled on-site and reduces assembly and maintenance time and costs.

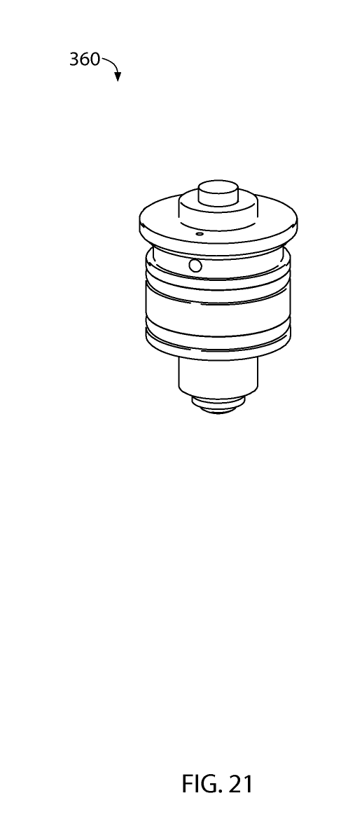

Referring now to FIGS. 21 through 23B, a pilot regulator valve 360 in accordance with one or more aspects of the present invention is shown. As can be seen in the Figures, the pilot regulator valve 360 is a self-contained cartridge configured for top loading into the pilot regulator manifold block 310.

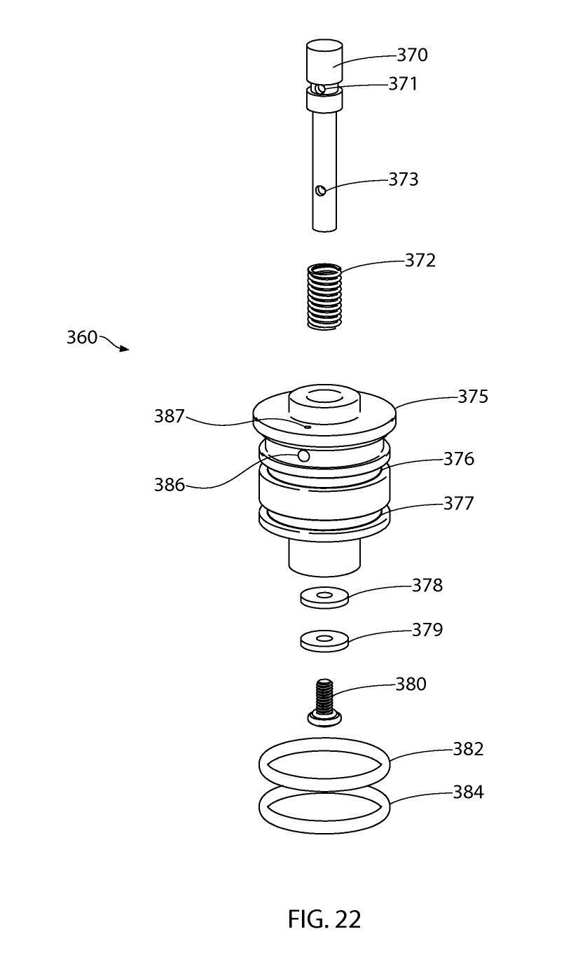

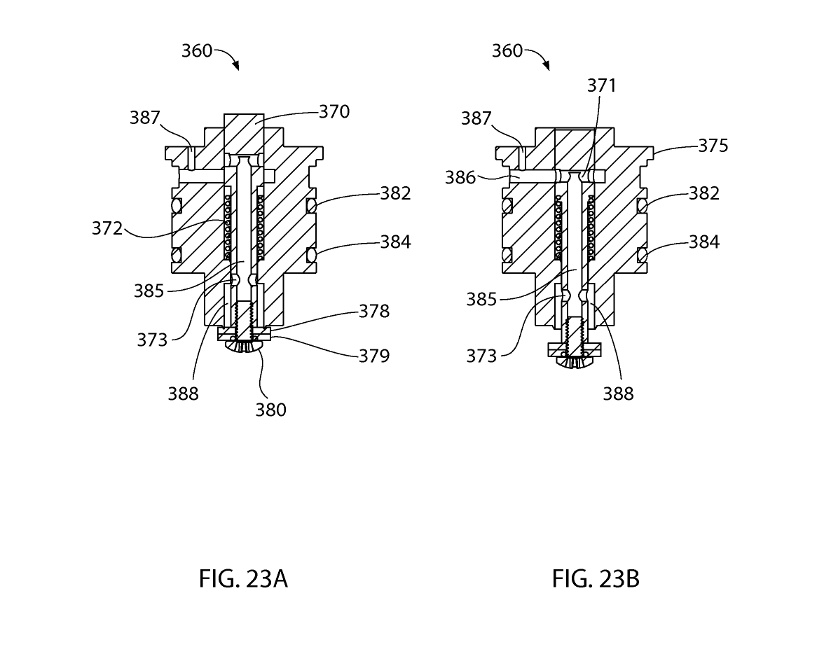

Referring now to FIGS. 22 through 23B, a pilot regulator valve 360 in accordance with one or more aspects of the present invention is shown. As can be seen in the Figures, the control valve 360 is a self-contained cartridge configured for top loading into the pilot regulator valve manifold block 310.

As shown in FIGS. 22 through 23B, the pilot regulator valve 360 may be comprised of a pilot regulator valve cartridge body 375 with a first and second valve cartridge body seal ring grooves 376, 377, first and second valve cartridge body seal rings 382, 384 disposed respective in the first and second seal ring grooves 376, 377, a valve spool 370, an internal regulator spring 372, a valve spool end screw 380, a metal washer 379, and a rubber seal gasket 378. As can be seen from the Figures, the pilot regulator valve 360 may be assembled by placing the internal regulator spring 372 into the top center hole of the valve cartridge body 375, extending the valve spool 370 through the center of the internal regulator spring 372 and the center of the valve cartridge body 375, then placing the washer 379 and the rubber seal gasket 378 around the valve spool end screw 380 and screwing the valve spool end screw into the threaded end of the valve spool so that the rubber seal gasket 378 is secured between the washer 379 and the bottom end of the valve spool 370.

As seen in FIGS. 23A and 23B, the valve spool has an internal channel 385 to allow gas to travel through the valve spool. The valve cartridge body also has fuel passages 386, 388 to permit fuel to travel through the pilot regulator valve 360 when the pilot regulator valve 360 is open. FIG. 23A shows a sectional view of a pilot regulator 360 in a closed position in accordance with one or more aspects of the present invention. FIG. 23B shows a sectional view of a pilot regulator 360 in a closed position in accordance with one or more aspects of the present invention. As can be seen from the Figures, when the valve spool 370 is depressed, the fuel outlet port 371 of the valve spool 370 may line up with the fuel outlet passage 386 of the valve cartridge body 375 and the fuel inlet port 373 or the valve spool 370 may line up with the fuel passage cavity 388 of the valve cartridge body 375 so that gas is permitted to travel through the pilot regulator valve 360.

When assembled the pilot regulator valve 360 comprises a single self-contained cartridge that may provide pilot regulator functionality when secured in the pilot regulator manifold block 310 in an assembled pilot regulator module 300. The configuration of the pilot regulator valve 360 within the pilot regulator manifold 362 of the pilot regulator manifold block 310 may provide for flow-under functionality. Fuel leaks from pressure around the pilot regulator valve 360 when it is secured in the pilot regulator manifold 362 may be prevented by the seal rings 382, 384 secured around the valve cartridge body 375 which create a seal between the pilot regulator valve cartridge 360 and the pilot regulator manifold block 310.

Fuel passing through the main fuel channel 134 in the pilot regulator manifold block 310 may be diverted up through the pilot regulator 360 and into a pilot fuel channel at a lower pressure.

One of the advantages of having a single valve cartridge body 375 with a valve spool 370 is that it allows configuration of a self-contained pilot regulator valve. One of the advantages of having a self-contained pilot regulator valve cartridge 360 is that the valve components may be assembled with the control valve train module 300 as a unit rather than separately. This reduces the risk of losing parts and reduces assembly time. Because the pilot regulator valve cartridges are self-contained, it also ensures alignment of the plugs and seats which do not need to be adjusted during installation.

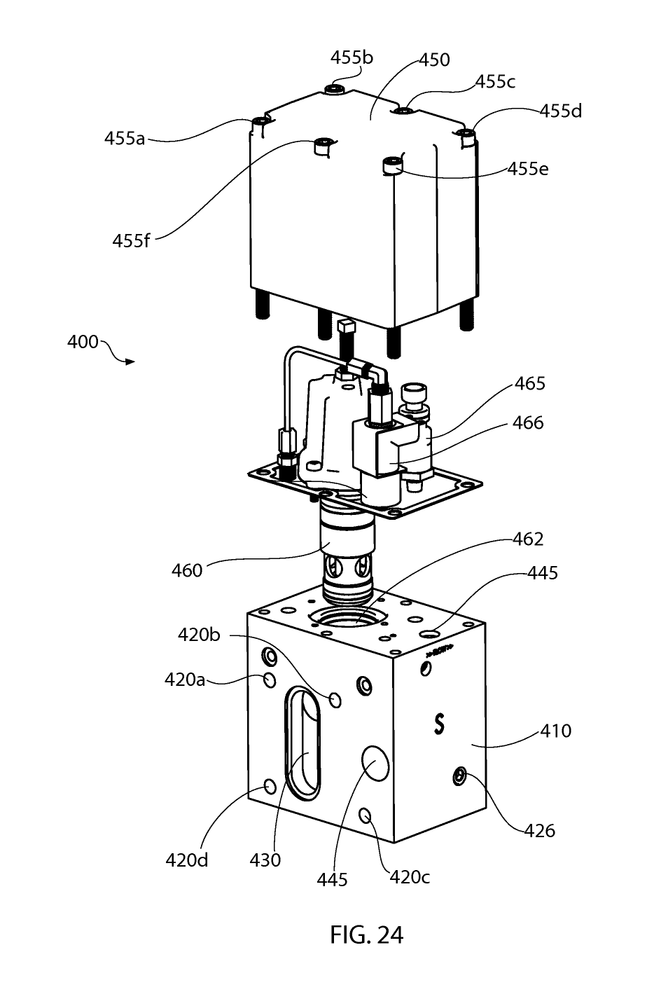

Turning now to FIGS. 24 through 29, a safety shut-off valve module 400 is disclosed in accordance with one or more aspects of the present invention. As shown in the Figures, the safety shut-off valve module 400 may be comprised of a safety shut-off valve manifold block 410, a self-contained top-loading safety shut-off valve cartridge 460, a pressure transducer 465, a three-way solenoid 466, and an explosion-proof housing cover 450 which may be secured on top the safety shut-off valve manifold block 410 using threaded bolts 455a, 455b, 455c, 455d, 455e, 455f.

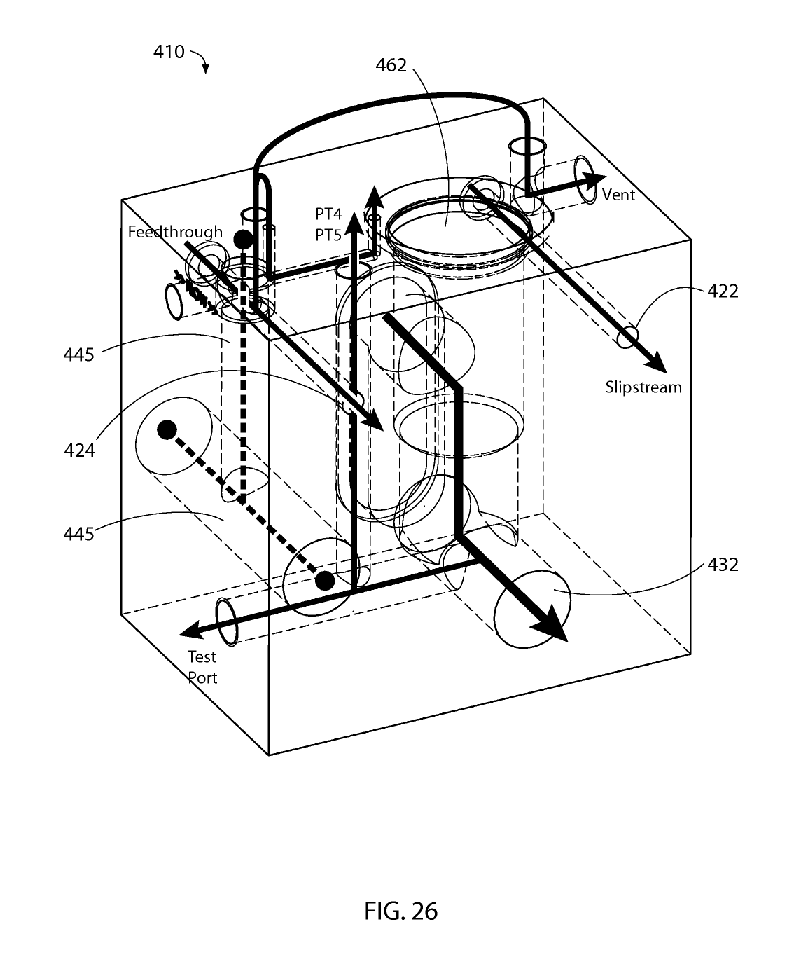

The safety shut-off valve manifold block 410 may have a safety shut-off valve manifold 462 for receiving and operably housing the safety shut-off valve cartridge 460. The self-contained top loading safety shut-off valve cartridge 460 may be secured in the safety shut-off valve manifold 462 using a snap ring. The pressure transducer 465 may be operably connected to a transducer port shown in FIG. 26 for measuring internal fuel pressure. The transducer port may be connected to either PT4 or PT5 depending on whether the shut-off valve module is a first or second SSV in a series. Alternatively, the PT number may be different as applicable if a different module sequence is used in the valve train system.

The safety shut-off valve manifold block 410 may also include an internally integrated main fuel channel 134, a main fuel channel inlet port 430 and main fuel channel outlet port 432, a pressure transducer fuel channel, a feed through gas channel, a test port, and a vent port. The safety shut-off valve module 400 may also include an electrical wire port 445 extending axially and vertically for integration of the valve train electrical system. Tie rod holes 420a, 420b, 420c, 420d may also be provided in the safety shut-off valve manifold block 410 for receiving tie rods used to secure the valve train 10 in a stacked formation.

The safety shut-off valve module 400 may be used as a fail-safe and quick stopping of fuel flow in addition to general use to ensure shut-off of fuel flow through the main fuel channel 134 to the burner. The safety shut-off valve 460 may be actuated by use of the three-way solenoid 466 operably connected to a control box or burner management system through the internally integrated electrical system of the integrated valve train 10. The three-way solenoid 466 may receive communications from the control box or burner management system to open, close or redirect gas flow and may be used to open or close an integrated feedthrough gas channel, shown in FIG. 26, which has been diverted from the internally integrated main gas channel 134 at the main regulator module 200, as shown in FIGS. 5 through 8. The three-way solenoid 466 may actuate the safety shut of valve by directing gas under the diaphragm of the safety shut-off valve and by opening ports to allow release of gas from the under the diaphragm and directing the released gas through a vent port.

The three-way solenoid 466 and safety shut-off valve 460 are integrated within the safety shut-off valve module 400. This provides increased safety by reducing leak paths. It also reduces the number of valve train components that must be assembled on-site.

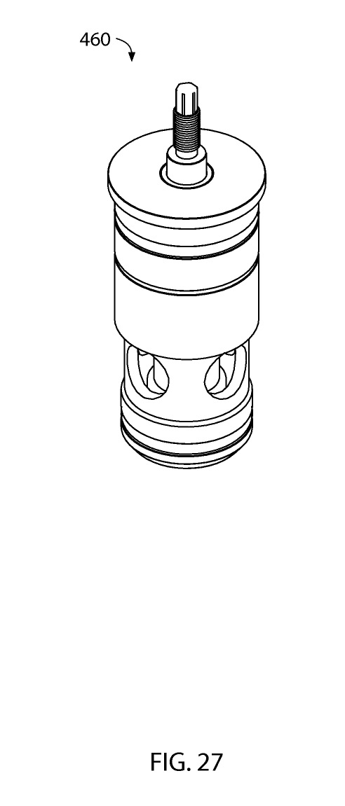

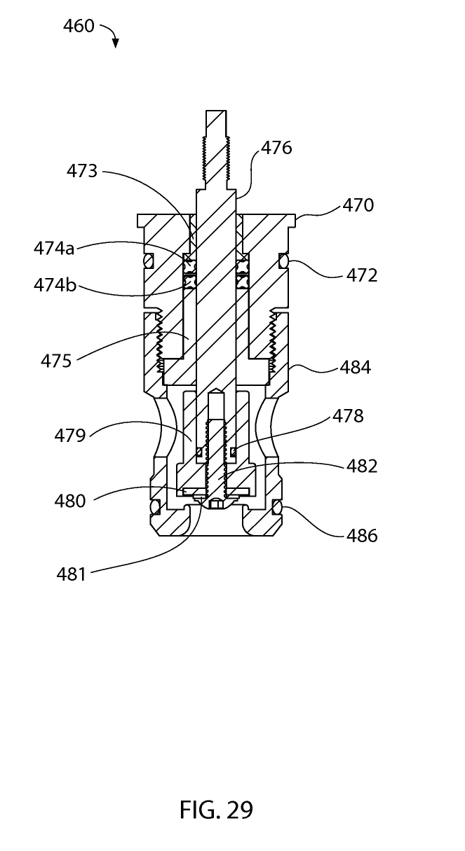

Referring now to FIGS. 27 through 29, a safety shut-off valve 460 in accordance with one or more aspects of the present invention is shown. As can be seen in the Figures, the safety shut-off valve 460 is a self-contained cartridge configured for top loading into the safety shut-off valve manifold block 410. As shown in FIGS. 27 and 29, the safety shut-off valve 460 may be comprised of a bonnet cartridge 470 having a bonnet seal ring groove 471, a bonnet seal ring 472 disposed in the bonnet seal ring groove 471, a stem 476 having a stem seal groove 477 around a bottom end and having a stem seal ring 478 disposed therein, the stem 476 being extended through a stem guide 475, two or more rubber Q-rings 474a, 474b, a stem bushing 473, and through the top center of the bonnet cartridge 470, wherein the two or more rubber Q-rings 474a, 474b are secured between the stem guide 475 and the stem bushing 473 and the stem bushing 473 is disposed in an upper internal cavity of the bonnet cartridge 470. As shown in the Figures, a shut-off valve plug head 479 may be connected to the bottom end of the stem 476 using a plug retaining screw 482 that may be extended through the shut-off valve plug head 479 and screwed into the threaded end of the stem 476. A metal washer 481 may be used to secure a rubber seal gasket to the bottom side of the shut-off valve plug head 479.

The safety shut-off valve 460 may be further comprised of a seat cartridge 484 having a seat cartridge seal ring groove 485 and a seat cartridge seal ring 486 disposed in the seal ring groove 485. The bonnet cartridge 270 and the seat cartridge 284 have threaded fittings so that the bonnet cartridge 270 and the seat cartridge 284 may be threaded together to provide a single self-contained safety shut-off valve cartridge wherein the bonnet and seat ring are directly connected.

When assembled the safety shut-off valve cartridge 460 comprises a single self-contained cartridge that may provide safety shut-off functionality when secured in the safety shut-off manifold block 410 in an assembled safety shut-off valve module 400. The configuration of the safety shut-off valve 460 within the safety shut-off manifold 462 of the safety shut-off manifold block 410 may provide for flow-over functionality. Fuel leaks from pressure around the safety shut-off valve cartridge 460 when it is secured in the safety shut-off valve manifold 462 may be prevented by the seal rings 472, 486 secured around the bonnet cartridge 470 and the seat cartridge 484 which create a seal between the safety shut-off valve cartridge 460 and the safety shut-off valve manifold block 410.

One of the advantages of connecting the bonnet and the seat of the safety shut-off valve directly is that it allows configuration of a self-contained safety shut-off valve. One of the advantages of having a self-contained safety shut-off valve cartridge is that the valve components may be assembled with the safety shut-off valve train module as a unit rather than separately. This reduces the risk of losing parts and reduces assembly time. Because the safety shut-off valve cartridges are self-contained, it also ensures alignment of the plugs and the seats which do not need to be adjusted during installation. Also, because fuel pressure around the self-contained top loading valve cartridges 260, 360, 460, 660 is managed within the respective manifold or housing blocks 200, 300, 400, 600, it reduces leak paths. Another advantage is that the valves may be easily installed, removed, and replaced without extensive time and labor costs because the valves are self-contained cartridges.

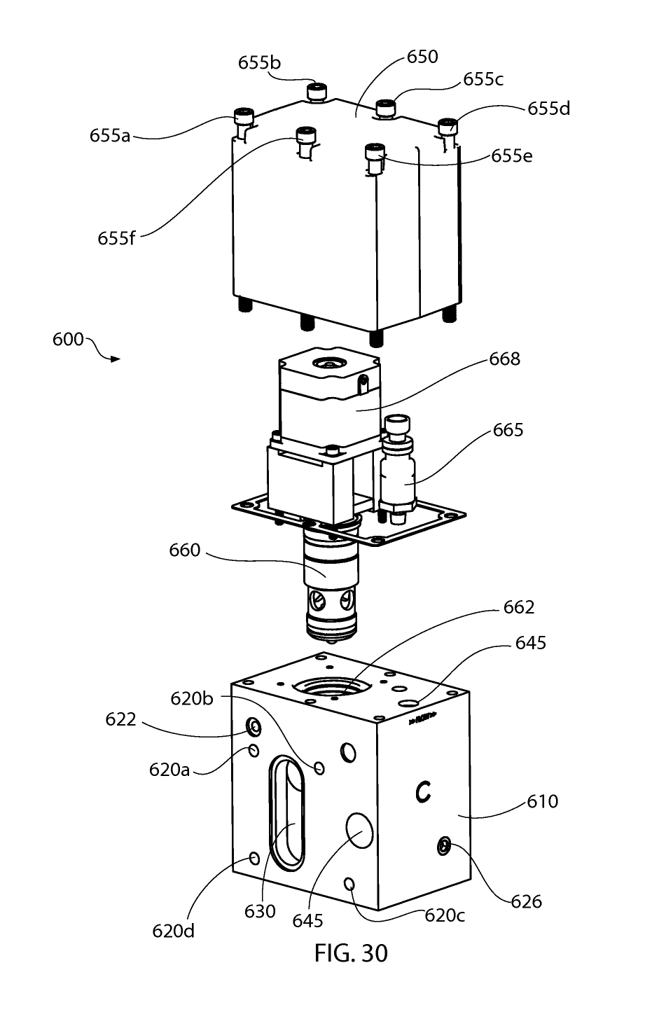

Turning now to FIGS. 30 through 35, a control valve module 600 is disclosed in accordance with one or more aspects of the present invention. As shown in the Figures, the control valve module 600 may be comprised of a control valve manifold block 610, a self-contained top-loading control valve cartridge 660, a pressure transducer 665, a control valve motor unit 668, and an explosion-proof housing cover 650 which may be secured on top the control valve manifold block 610 using threaded bolts 655a, 655b, 655c, 655d, 655e, 655f.

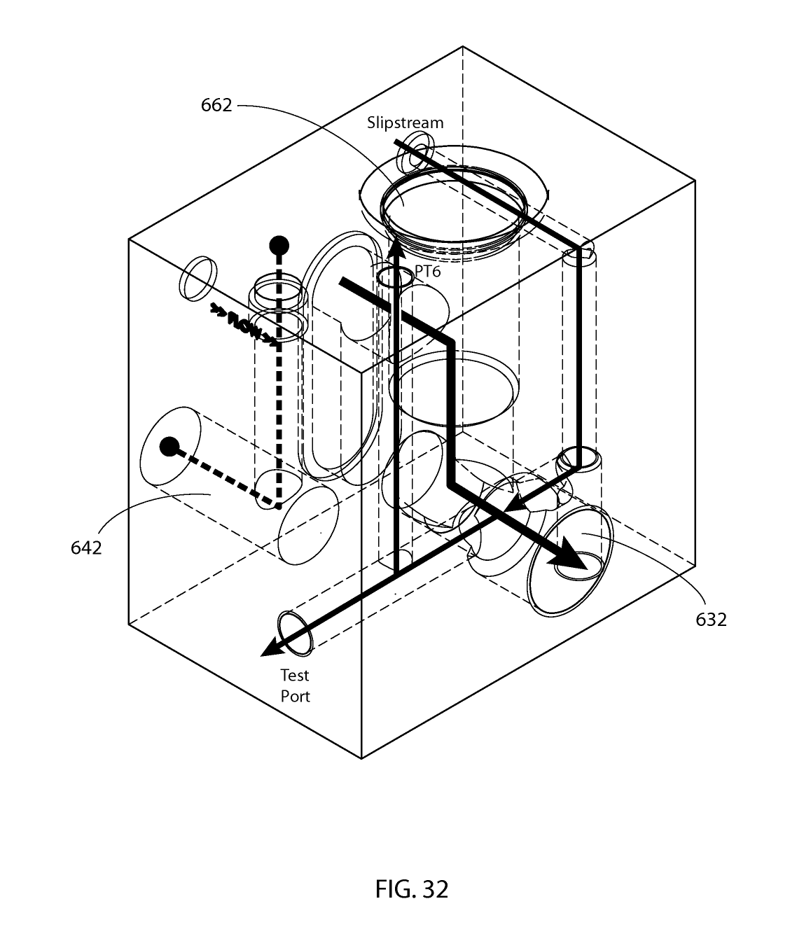

The control valve manifold block 610 may have a control valve manifold 662 for receiving and operably housing the control valve cartridge 660. The self-contained top loading control valve cartridge 660 may be secured in the control valve manifold 662 using a snap ring. The pressure transducer 665 may be operably connected to a transducer port shown in FIG. 32 for measuring internal fuel pressure.

The control valve manifold block 610 may also include an internally integrated main fuel channel 134, a main fuel channel inlet port 630 and main fuel channel outlet port 632, a pressure transducer fuel channel, an upstream pilot fuel channel port 622 connected to the internally integrated pilot of slipstream fuel channel, and a test port. In some configurations, the manifold block 610 may also include a common vent port. The control valve module 600 may also include an electrical wire port 645 extending axially and vertically for integration of the valve train electrical system. Threaded tie rod holes 620a, 620b, 620c, 620d may also be provided in the control valve manifold block 410 for receiving tie rods used to secure the valve train 10 in a stacked formation.

The control valve module 600 may be used to control conditions such as fuel flow, pressure, and temperature. The control valve 660 may be actuated by use of the control motor 668 which may be operably connected to a power source and the control box or burner management system through the internally integrated electrical system of the integrated valve train 10. The control motor unit 668 may receive communications from the control box or burner management system to open, close, or adjust the flow of gas to the burner through the internally integrated main fuel channel 135.

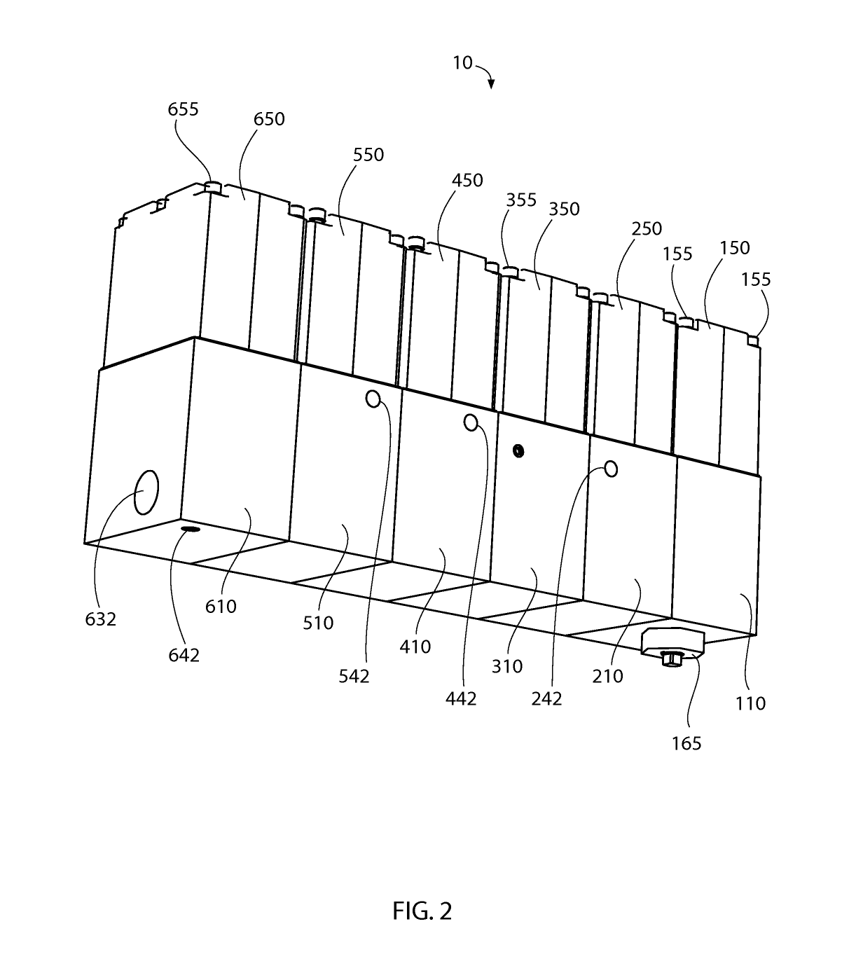

As shown in FIG. 2, the control valve manifold block 610 may include a pilot fuel channel port 642 connected to the pilot or slip-stream fuel channel. A threaded plug may be removed from the port 642 to access an internal plug which is used to block the slipstream pathway to the main fuel channel 134 within the control valve manifold block 610 as seen in FIG. 32. When the internal threaded plug is removed by unscrewing it and then the outer plug for the pilot fuel channel port 642 is reinserted, then the control valve module 600 is configured for slip-stream functionality.

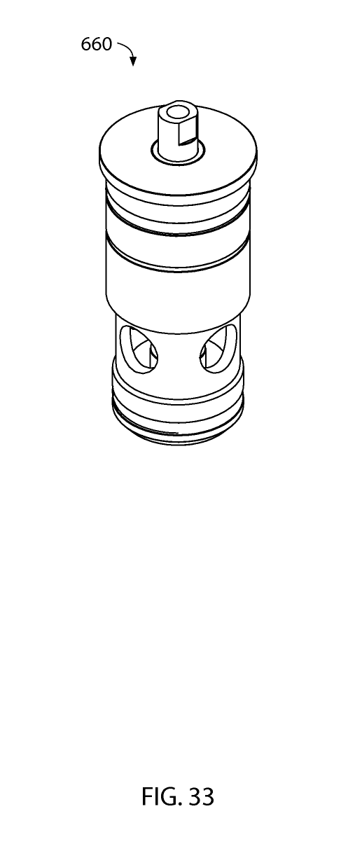

Referring now to FIGS. 33 through 35, a control valve 660 in accordance with one or more aspects of the present invention is shown. As can be seen in the Figures, the control valve 660 is a self-contained cartridge configured for top loading into the control valve manifold block 610.

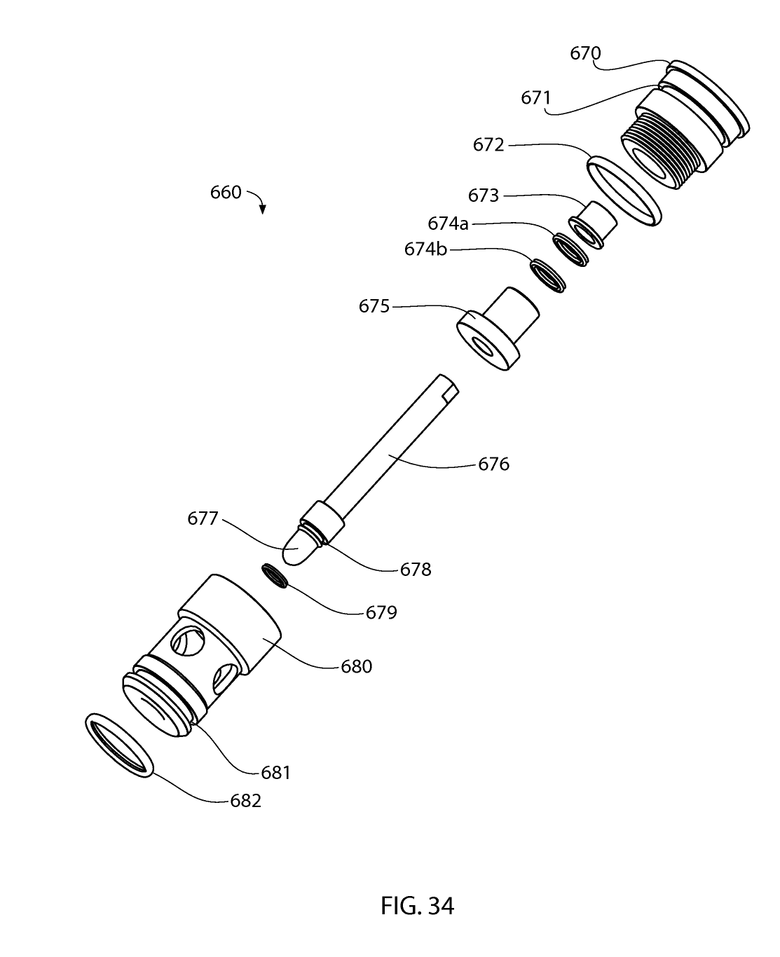

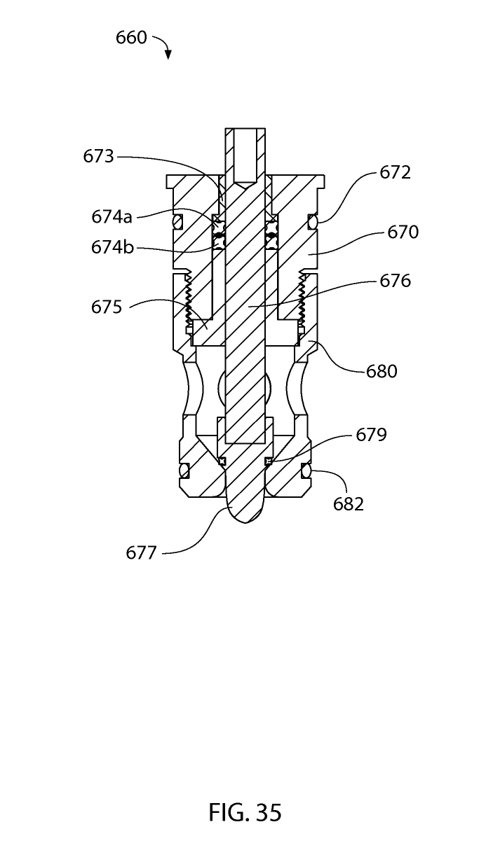

As shown in FIGS. 34 and 35, the control valve 660 may be comprised of a bonnet cartridge 670 having a bonnet seal ring groove 671, a bonnet seal ring 672 disposed in the bonnet seal ring groove 671, a stem 676, a plug head 677 having a plug head seal groove 678 and having a plug head seal ring 679 disposed therein, the stem 676 being extended through a stem guide 675, two or more rubber Q-rings 674a, 674b, a stem bushing 673, and through the top center of the bonnet cartridge 670, wherein the two or more rubber Q-rings 674a, 674b are secured between the stem guide 675 and the stem bushing 673 and the stem bushing 673 is disposed in an upper internal cavity of the bonnet cartridge 670.

The control valve 660 may be further comprised of a seat cartridge 680 having a seat cartridge seal ring groove 681 and a seat cartridge seal ring 682 disposed in the seal ring groove 681. The bonnet cartridge 670 and the seat cartridge 680 have threaded fittings so that the bonnet cartridge 670 and the seat cartridge 680 may be threaded together to provide a single self-contained control valve cartridge 660 wherein the bonnet and seat ring are directly connected.

When assembled the control valve cartridge 660 comprises a single self-contained cartridge that may provide control valve functionality when secured in the control valve manifold block 610 in an assembled control valve module 600. The configuration of the control valve 660 within the control valve manifold 662 of the control valve manifold block 610 may provide for flow-over functionality. Fuel leaks from pressure around the control valve 660 when it is secured in the control valve manifold 662 may be prevented by the seal rings 672, 681 secured around the bonnet cartridge 670 and the seat cartridge 680 which create a seal between the control valve cartridge 660 and the control valve manifold block 610.

One of the advantages of connecting the bonnet and the seat of the control valve directly is that it allows configuration of a self-contained control valve. One of the advantages of having a self-contained control valve cartridge is that the valve components may be assembled with the control valve train module 600 as a unit rather than separately. This reduces the risk of losing parts and reduces assembly time. Because the control valve cartridges are self-contained, it also ensures alignment of the plugs and the seats which do not need to be adjusted during installation.

Also, because fuel pressure around the self-contained top loading valve cartridges 260, 360, 460, 660 is managed within the respective manifold or housing blocks 200, 300, 400, 600, it reduces leak paths. Another advantage is that the valves may be easily installed, removed, and replaced without extensive time and labor costs because the valves are self-contained cartridges.

There is thus disclosed an improved valve train system, apparatus, components, and methods, including valve train modules having internal and integrated valve train features and functions, self-contained top loading regulator and valve cartridges, an integrated valve proving system and an integrated valve train electrical system. It will be appreciated that numerous changes may be made to the present invention without departing from the scope of the claims.

What is claimed is:

1. A valve train system for use with an oil or gas processing combustion application comprising:
a plurality of valve train modules wherein each valve train module includes a valve manifold block; each valve manifold block having a internally configured fuel channel, a manifold disposed in the valve manifold block wherein the manifold is connected to the internally configured fuel channel, a fuel inlet port connected to the internally configured fuel channel at an upstream side of the valve manifold block; a fuel outlet port for egress of fuel from the internally configured fuel channel at a downstream side of the valve manifold block;
wherein each valve manifold block of the plurality of valve train modules is sequentially connected to at least one other valve manifold block so that the plurality of valve train modules are configured in a stack formation so that one or more valve train modules are disposed end-to-end between a first upstream valve train module and an end downstream valve train module;
wherein the fuel outlet port of each valve train module upstream from the end downstream valve train module connects to the fuel inlet port of a subsequent downstream valve train module so that the internally configured fuel channel of each valve train module forms a single internally integrated fuel channel; and
wherein each valve train module is configured to perform at least one function of a valve train.

2. The valve train system of claim 1, wherein at least two of the valve train modules include a shut-off valve cartridge housed in the manifold of each of the at least two valve train modules.

3. The valve train system of claim 2, wherein the first upstream valve train module includes a fuel strainer and the end downstream valve train module has a control valve housed in the manifold of the end downstream valve train module.

4. The valve train system of claim 2, wherein a sequence from upstream to downstream of the plurality of valve train modules comprises a y-strainer module followed by a regulator module followed by a pilot regulator module followed by first safety shut-off valve module followed by a second safety shut-off valve module followed by a control valve module.

5. The valve train system of claim 4, having an integrated valve proving system comprising
a first pressure transducer disposed in a first pressure transducer port in a manifold block of the regulator module wherein the first transducer port is connected to the internally configured fuel channel downstream for a regulator valve; and
a second pressure transducer disposed in a second pressure transducer port in a manifold block of the first safety-shut-off valve module wherein the second transducer port is connected to the internally configured fuel channel downstream of a first safety shut-off valve; and
a third pressure transducer disposed in a third pressure transducer port in a manifold block of the second safety-shut-off valve module wherein the third transducer port is connected to the internally configured fuel channel downstream of a second safety shut-off valve.

6. The valve train system of claim 1, wherein the plurality of valve train modules are secured in the stack configuration using a plurality of tie rods.

7. A valve train module comprising:
a valve manifold block having a first fuel channel comprising an internal fuel path within the valve manifold block wherein the first fuel channel includes a fuel inlet port at an upstream side of the valve manifold block and a fuel outlet port at a downstream side of the valve manifold block;
the valve manifold block further having a second fuel channel comprising an internal fuel path within the valve manifold block wherein the second fuel channel includes a fuel outlet port at a downstream side of the valve manifold block;
a solenoid disposed in a solenoid port on the valve manifold block wherein the solenoid port is connected to the second fuel channel;
a valve manifold formed within the valve manifold block and configured for receiving and operably housing a valve cartridge, wherein the valve manifold opens into the first fuel channel and wherein the valve manifold has an opening for inserting the valve cartridge on a side of the valve manifold block that is perpendicular to an axis of the first fuel channel; and
a valve cartridge secured within the valve manifold of the valve manifold block.

8. The valve train module of claim 7, wherein the second fuel channel includes a fuel inlet internally connected to the first fuel channel within the valve manifold block.

9. The valve train module of claim 7, wherein the second fuel channel includes a fuel inlet port opening to the upstream side of the valve manifold block.

10. The valve train module of claim 7, wherein the valve cartridge is a regulator cartridge.

11. The valve train module of claim 10, wherein the regulator cartridge has a bonnet cartridge directly connected to a seat cartridge.

12. The valve train module of claim 11, wherein the regulator cartridge is a self-contained valve cartridge.

13. The valve train module of claim 7, wherein the valve cartridge is a shut-off valve cartridge.

14. The valve train module of claim 13, wherein the shut-off valve cartridge has a bonnet cartridge directly connected to a seat cartridge.

15. The valve train module of claim 14, wherein the shut-off valve cartridge is a self-contained valve cartridge.

16. The valve train module of claim 7, wherein the valve cartridge is a control valve cartridge.

17. The valve train module of claim 16, wherein the control valve cartridge has a bonnet cartridge directly connected to a seat cartridge.

18. The valve train module of claim 17, wherein the control valve cartridge is a self-contained valve cartridge.

19. The valve train module of claim 7, wherein the valve cartridge is a pilot regulator valve cartridge.

20. A self-contained valve cartridge comprising:
a singular body bonnet cartridge;
a singular body seat cartridge having a valve seat; and
a valve stem connected to a valve plug;
wherein the singular body bonnet cartridge is secured directly to the singular body seat cartridge and the valve stem and valve plug are configured so that the valve plug may operably engage the valve seat.
